(19) United States
(12) Patent Application Publication
(10) Pub. No.: US 2015/0141115 A1
(43) Pub. Date: May 21, 2015

(54) Gaming Machine with Dice Attributes

(71) Applicant: Pridefield Limited, Douglas (IM)

(72) Inventors: Richard Vermaak, Durban (ZA); Theo Naicker, La Lucia (ZA); Terence Igesund, Prestondale (ZA)

(21) Appl. No.: 14/543,594

(22) Filed: Nov. 17, 2014

(30) Foreign Application Priority Data
Nov. 18, 2013 (GB) 1320352.6

(51) Int. Cl. G07F 17/32; G07F 17/34

(52) U.S. Cl. CPC G07F 17/3213; G07F 17/34
USPC 463/20

(57) ABSTRACT

A machine includes a display; a processor; and a non-transitory computer-readable medium storing program instructions, that when executed by the processor, cause a set of functions to be performed that include: making a determination that a trigger event occurred; displaying a selected symbol table; responsive to making the determination, for each symbol cell in the selected symbol table: randomly selecting a multiplier symbol; adding the selected multiplier symbol to a symbol cell, wherein the selected multiplier symbol corresponds to a displayable image component, wherein the displayable image component is from an image component set, and wherein the image component set corresponds to an image; adding the displayable image component to a selected image component set when the image component is not in the selected image component set; displaying the added displayable image component; and determining whether the selected image component set includes each image component of the image component set.

### PRIORITY

This application claims priority under 35 U.S.C. §119 to United Kingdom Patent Application No. 1320352.6 filed Nov. 18, 2013, which is hereby incorporated by reference in its entirety.

### TECHNICAL FIELD

This disclosure relates to gaming machines for playing games such as wager games.

### BACKGROUND

Wager games come in a variety of forms, including for example a mechanical slot machine. A mechanical slot machine may include one or more reels, each of which includes multiple symbols distributed around the circumference of the reel. When a player places a wager (e.g., by placing a coin in the machine), the player is allowed to spin the reels. Each reel then comes to rest, typically with either one of the symbols, or a space in between symbols, in alignment with a pay line. A predetermined winning symbol or a predetermined combination of winning symbols that are aligned with the pay line may result in the player winning the game and receiving a payout. In one example, the machine may include three reels, and the pay line may be a horizontal line disposed across a center of each of the three reels.

While slot machines were traditionally mechanical, modern slot machines often take the form of a video gaming machine (e.g., a dedicated gaming machine located in a casino) that includes a graphical user interface (GUI), and that may emulate a mechanical slot machine. With a video gaming machine, the GUI may include a display that displays an image of one or more reels or a matrix as described above, together with animation effects to simulate a spin of the game. A computer software program, which may reside in the video gaming machine, may randomly select one or more symbols in response to a spin, and may display the result on the display.

Modern slot machines may include additional features beyond that of a traditional slot machine. Such features may include additional play modes. These additional play modes may resemble other types of wager games, such as games played with dice. Such additional play modes may take the form of a bonus round that may increase the payout of the wager game under certain conditions.

A modern slot machine may also be played over a computer network, such as by a player using a client machine that is connected to a server machine over the computer network. In this instance, the server machine may perform the spins of the game and may send the resulting symbols to the client machine for display.

### SUMMARY

Viewed from one aspect, the disclosure describes a gaming machine for playing a game in which symbols are selected and/or displayed by the machine, the machine comprising means for selecting symbols and means for displaying symbols characterised in that the machine is configured to carry out the following functions: making a determination that a trigger event occurred; displaying on the display a selected symbol table comprising a plurality of symbol cells; responsive to making the determination, for each symbol cell in the selected symbol table: (i) randomly selecting a multiplier symbol from a multiplier symbol set; (ii) adding the selected multiplier symbol to a symbol cell of the selected symbol table, wherein the selected multiplier symbol corresponds to a displayable image component, wherein the displayable image component is from an image component set, and wherein the image component set corresponds to an image; (iii) adding the displayable image component to a selected image component set when the image component is not in the selected image component set; (iv) displaying on the display the added displayable image component of the selected image component set; and (v) determining whether the selected image component set includes the or each image component of the image component set.

In some embodiments, the trigger event comprises a randomly occurring event. For instance, the trigger event may involve the machine selecting a particular trigger symbol, such as in connection with a previous play of the game.

In some embodiments, at least one symbol cell of the plurality of symbol cells does not have a multiplier symbol. In such embodiments, the machine may be further configured to, for the or each symbol cell in the selected symbol table that does not have a multiplier symbol, add a multiplier symbol from the multiplier symbol set to the selected symbol table when the selected image component set includes each image component of the image component set.

The machine may be further configured for displaying on the display the image, wherein the image is composed of the or each respective displayable image component of the selected image component set when the selected image component set includes the or each image component of the image component set.

Likewise, in some embodiments, the machine may be configured for displaying on the display the or each respective displayable image component of the image component set.

In some embodiments, the machine may be configured to, for the or each selected multiplier symbol in the symbol table, determining a respective multiplier bonus amount, wherein the multiplier bonus amount is a function of the respective multiplier and the wager. In such embodiments, for the or each selected multiplier symbol in the symbol table, the machine may display on the display the determined respective multiplier bonus amount.

In some embodiments, the game may be a wager game and the machine may be further configured for receiving a wager via a user interface, determining, using a stored payout table, a payout amount, and displaying on the display the determined payout amount. The payout amount may be a function of the received wager, one or more respective multipliers that are associated with the or each respective selected multiplier symbol, and/or a sum of the respective multiplier bonus amounts. In some embodiments, the payout amount may be augmented by a bonus amount when the selected image component set includes each image component of the image component set. The machine may be further configured to display on the display the determined payout amount and/or the bonus amount.

The machine may further be configured for receiving a play request via a user interface. In this instance, the machine may make the determination in response to receiving the play request.

The or each respective multiplier symbol of the multiplier symbol set may indicate a respective die face. Further, the multiplier symbol set may comprises six multiplier symbols.

In some embodiments, the or each respective multiplier symbol of the multiplier symbol set may indicate a respective slot on a spinner.

In some embodiments, randomly selecting a multiplier symbol from a multiplier symbol set comprises using a random number generator to select numbers from a set of numbers to select multiplier symbols corresponding with the selected numbers.

The machine may be further configured to, responsive to making the determination, for the or each symbol cell in a selected symbol table, display on the display the selected multiplier symbol.

In some embodiments, displaying on the display the added image component of the selected image component set comprises highlighting the added image component.

In some embodiments, the machine may be further configured to display on the display an outline of the image. In such embodiments, displaying on the display the added displayable image component may comprise displaying the added displayable image component within the outline of the image.

In some embodiments, randomly selecting a multiplier symbol from a multiplier symbol set may comprise making a second determination that a second trigger event occurred, and responsive to the second determination, randomly selecting a multiplier symbol from the multiplier symbol set.

In some embodiments, the selected symbol table may include a first amount of symbol cells, the multiplier symbol set may include a second amount of multiplier symbols, and the first amount may be greater than the second amount.

The machine may be in the form of a stand alone gaming machine which incorporates a data processing module and a display. Alternatively, the machine may comprise a server machine and a client machine which incorporates a data processing module and a display, the server machine and the client machine being remote from each other.

Viewed from a second aspect, the disclosure describes a method for playing a game in which symbols are selected and/or displayed, the method comprising: a machine making a determination that a trigger event occurred; the machine displaying on the display a selected symbol table comprising a plurality of symbol cells; responsive to making the determination, for each symbol cell in the selected symbol table, the machine: (i) randomly selecting a multiplier symbol from a multiplier symbol set; (ii) adding the selected multiplier symbol to a symbol cell of the selected symbol table, wherein the selected multiplier symbol corresponds to a displayable image component, wherein the displayable image component is from an image component set, and wherein the image component set corresponds to an image; (iii) adding the displayable image component to a selected image component set when the image component is not in the selected image component set; (iv) displaying on the display the added displayable image component of the selected image component set; and (v) determining whether the selected image component set includes the or each image component of the image component set.

Viewed from a third aspect, the disclosure describes a server machine for use in playing a game in which symbols are selected and/or displayed, the server machine being configured to communicate with a client machine over a computer network, and the server machine comprising a processor and a computer-readable medium storing software instructions, that when executed by the processor, perform functions on the server machine comprising: making a determination that a trigger event occurred; sending to a client machine for display a selected symbol table comprising a plurality of symbol cells; responsive to making the determination, for each symbol cell in the selected symbol table: (i) randomly selecting a multiplier symbol from a multiplier symbol set; (ii) adding the selected multiplier symbol to a symbol cell of the selected symbol table, wherein the selected multiplier symbol corresponds to a displayable image component, wherein the displayable image component is from an image component set, and wherein the image component set corresponds to an image; (iii) adding the displayable image component to a selected image component set when the image component is not in the selected image component set; (iv) sending to the client machine for display the added displayable image component of the selected image component set; and (v) determining whether the selected image component set includes the or each image component of the image component set.

Viewed from a fourth aspect, the disclosure describes a client machine for playing a game in which symbols are selected and/or displayed, the client machine being in communication with a server machine and comprising: a display configured to display symbols; a processor; and a computer-readable medium storing software instructions, that when executed by the processor, perform functions on the client machine, the functions comprising: making a determination that a trigger event occurred; displaying on the display a selected symbol table comprising a plurality of symbol cells; responsive to making the determination, for each symbol cell in the selected symbol table, the client machine: (i) receiving from the server machine a multiplier symbol from a multiplier symbol set; (ii) adding the selected multiplier symbol to a symbol cell of the selected symbol table, wherein the selected multiplier symbol corresponds to a displayable image component, wherein the displayable image component is from an image component set, and wherein the image component set corresponds to an image; (iii) adding the displayable image component to a selected image component set when the image component is not in the selected image component set; (iv) displaying on the display the added displayable image component of the selected image component set; and (v) receiving from the server machine a determination whether the selected image component set includes the or each image component of the image component set.

Viewed from a fifth aspect, the disclosure describes a computer software product for configuring a data processing system for playing a game in which symbols are selected and/or displayed, the software product comprising instructions, that when executed by a processor of the data processing system will cause the data processing system to carry out the following functions: making a determination that a trigger event occurred; displaying on the display a selected symbol table comprising a plurality of symbol cells; responsive to making the determination, for each symbol cell in the selected symbol table: (i) randomly selecting a multiplier symbol from a multiplier symbol set; (ii) adding the selected multiplier symbol to a symbol cell of the selected symbol table, wherein the selected multiplier symbol corresponds to a displayable image component, wherein the displayable image component is from an image component set, and wherein the image component set corresponds to an image; (iii) adding the displayable image component to a selected image component set when the image component is not in the selected image component set; (iv) displaying on the display the added displayable image component of the selected image component set; and (v) determining whether the selected image component set includes the or each image component of the image component set.

The features listed above as being features of embodiments of the first aspect of the disclosure, are equally applicable to embodiments of the second, third, fourth and fifth aspects of the disclosure.

In embodiments of the disclosure in which a computer software product is used, the product may be non-transitory and store instructions on physical media such as a DVD, or a solid state drive, or a hard drive. Or, the product may be an integrated circuit on a semiconductor chip, as a further example. Alternatively, the product may be transitory and in the form of instructions provided over a connection such as a network connection which is linked to a network such as the Internet.

Disclosed herein are machines and methods for playing games such as wager games. In one aspect, a machine is disclosed that includes a display configured to display symbols in a game, a processor, and a non-transitory computer-readable medium storing software program instructions, that when executed by the processor, cause a set of functions to be performed. The set of functions includes: making a determination that a trigger event occurred; displaying on the display a selected symbol table comprising a plurality of symbol cells; responsive to making the determination, for each symbol cell in the selected symbol table: (i) randomly selecting a multiplier symbol from a multiplier symbol set; (ii) adding the selected multiplier symbol to a symbol cell of the selected symbol table, wherein the selected multiplier symbol corresponds to a displayable image component, wherein the displayable image component is from an image component set, and wherein the image component set corresponds to an image; (iii) adding the displayable image component to a selected image component set when the image component is not in the selected image component set; (iv) displaying on the display the added displayable image component of the selected image component set; and (v) determining whether the selected image component set includes the or each image component of the image component set.

In another aspect, a method for use with a machine comprising a processor, and a display configured to display symbols in a game is disclosed. The method involves: making, using a machine, a determination that a trigger event occurred; the machine displaying on the display a selected symbol table comprising a plurality of symbol cells; responsive to making the determination, for each symbol cell in the selected symbol table, the machine: (i) randomly selecting a multiplier symbol from a multiplier symbol set; (ii) adding the selected multiplier symbol to a symbol cell of the selected symbol table, wherein the selected multiplier symbol corresponds to a displayable image component, wherein the displayable image component is from an image component set, and wherein the image component set corresponds to an image; (iii) adding the displayable image component to a selected image component set when the image component is not in the selected image component set; (iv) displaying on the display the added displayable image component of the selected image component set; and (v) determining whether the selected image component set includes the or each image component of the image component set.

In another aspect, a server machine is disclosed. The server machine is configured to communicate with a client machine over a computer-network, the client machine including a display configured to display symbols in a game. The server machine includes a processor and a non-transitory computer-readable medium storing software instructions, that when executed by the processor, perform a set of functions. The set of functions includes: making a determination that a trigger event occurred; sending to a client machine for display a selected symbol table comprising a plurality of symbol cells; responsive to making the determination, for each symbol cell in the selected symbol table: (i) randomly selecting a multiplier symbol from a multiplier symbol set; (ii) adding the selected multiplier symbol to a symbol cell of the selected symbol table, wherein the selected multiplier symbol corresponds to a displayable image component, wherein the displayable image component is from an image component set, and wherein the image component set corresponds to an image; (iii) adding the displayable image component to a selected image component set when the image component is not in the selected image component set; (iv) sending to the client machine for display the added displayable image component of the selected image component set; and (v) determining whether the selected image component set includes the or each image component of the image component set.

In another aspect, a client machine is disclosed. The client machine is configured to communicate with a server machine over a computer network. The client machine includes a display configured to display symbols of a game, a processor, and a non-transitory computer-readable medium storing software instructions, that when executed by the processor, perform a set of functions. The set of functions includes: making a determination that a trigger event occurred; displaying on the display a selected symbol table comprising a plurality of symbol cells; responsive to making the determination, for each symbol cell in the selected symbol table, the client machine: (i) receiving from the server machine a multiplier symbol from a multiplier symbol set; (ii) adding the selected multiplier symbol to a symbol cell of the selected symbol table, wherein the selected multiplier symbol corresponds to a displayable image component, wherein the displayable image component is from an image component set, and wherein the image component set corresponds to an image; (iii) adding the displayable image component to a selected image component set when the image component is not in the selected image component set; (iv) displaying on the display the added displayable image component of the selected image component set; and (v) receiving from the server machine a determination whether the selected image component set includes the or each image component of the image component set.

### BRIEF DESCRIPTION OF THE DRAWINGS

Some embodiments of the disclosure will now be described by way of example and with reference to the accompanying drawings, in which:

FIG. 1 is a simplified block diagram of an embodiment of a machine in accordance with the disclosure;

FIG. 2 is a simplified block diagram of an example server machine connected to an example client machine over a computer-network, in an embodiment of the disclosure;

FIG. 3A is a first part of a flow chart showing functions in accordance with a method in an embodiment of the disclosure;

FIG. 3B is a second part of the flow chart of FIG. 3A;

FIG. 3C is a third part of the flow chart of FIG. 3A;

FIG. 3D is a fourth part of the flow chart of FIG. 3A;

FIG. 4A includes diagrams of tables used in accordance with machines and methods in embodiments of the disclosure;

FIG. 4B includes additional diagrams of tables used in accordance with machines and methods in embodiments of the disclosure;

FIG. 5 depicts a first state of a display in accordance with an embodiment of a machine and method in accordance with the disclosure;

FIG. 6 depicts a second state of a display in accordance with an embodiment machine and method in accordance with the disclosure;

FIG. 7 depicts a third state of a display in accordance with an embodiment machine and method in accordance with the disclosure;

FIG. 8 depicts a fourth state of a display in accordance with an embodiment machine and method in accordance with the disclosure;

FIG. 9 depicts a fifth state of a display in accordance with an embodiment machine and method in accordance with the disclosure;

FIG. 10 depicts a sixth state of a display in accordance with an embodiment machine and method in accordance with the disclosure;

FIG. 11A is a first part of a flow chart showing functions in accordance with another method in an embodiment of the disclosure, in connection with an example server machine;

FIG. 11B is a second part of the flow chart of FIG. 11A;

FIG. 11C is a third part of the flow chart of FIG. 11A;

FIG. 11D is a fourth part of the flow chart of FIG. 11A;

FIG. 12A is a first part of a flow chart showing functions in accordance with another method in an embodiment of the disclosure, in connection with an example client machine;

FIG. 12B is a second part of the flow chart of FIG. 12A;

FIG. 12C is a third part of the flow chart of FIG. 12A; and

FIG. 12D is a fourth part of the flow chart of FIG. 12A.

### DETAILED DESCRIPTION

Throughout this disclosure, any reference to “a” or “an” refers to “at least one,” and any reference to “the” refers to “the at least one,” unless otherwise specified, or unless the context clearly dictates otherwise.

Disclosed herein are machines and methods for playing games such as wager games. In one aspect, the machines and methods provide a feature that enhances traditional wager games (e.g., slot machines or other reel-type games) by providing a player with additional opportunities to win the game, thereby increasing the player's interest, anticipation, and excitement in connection with the game. This may in turn benefit a casino or another entity that provides a game with this feature. Indeed, wager games are typically configured to have odds that favor the casino (sometimes referred to as the “house”). Accordingly, based on the law of averages, casinos often maximize their profits simply by getting more players to play more games. Due to the provided feature, players may be drawn in (e.g., from competing casinos that lack games with such a feature) and they may play the game often.

In another aspect, the wager game may be played using non-monetary credits. In such embodiments, the player may not lose or win any money. Further, in such embodiments, the wager game may simulate gambling, without actually allowing the player to gamble money. In some embodiments, the non-monetary credits may be used to unlock additional features within the game, which may encourage the player to play the game.

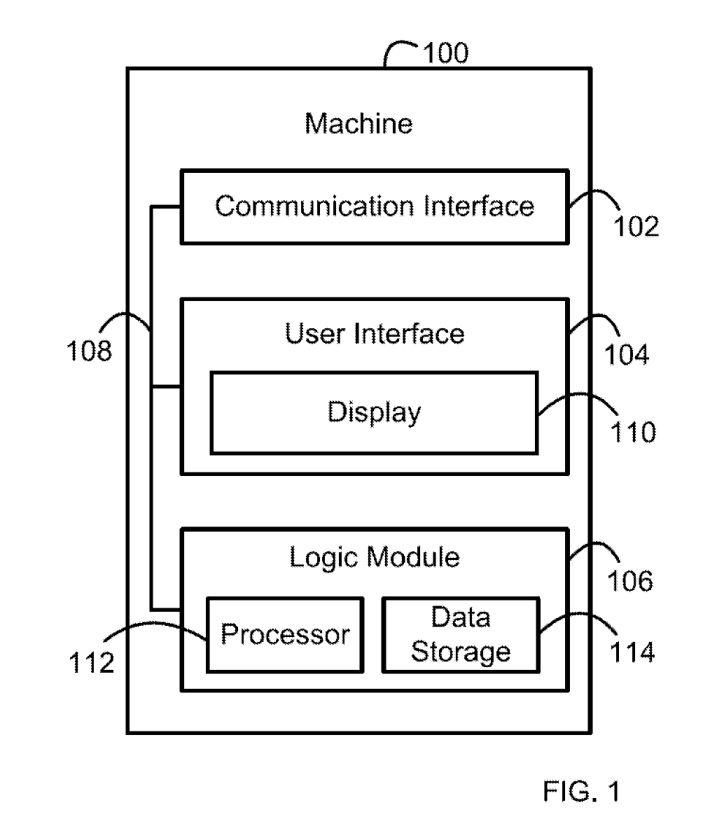

FIG. 1 shows a simplified block diagram of an example machine 100 arranged to implement functions in accordance with example methods described herein. The machine 100 may take any of a variety of forms, including for example a dedicated gaming machine, personal computer, desktop computer, laptop computer, personal digital assistant, mobile phone, smart phone, tablet device, or other computing device.

The machine 100 may include a communication interface 102, a user interface 104, and a logic module 106, all of which may be coupled together by a system bus, network, or other connection mechanism 108. The communication interface 102 may include a wired or wireless network communication interface.

The user interface 104 may facilitate interaction with a user (e.g., a player of a game) if applicable. As such, the user interface 104 may take the form of a GUI and may include output components such as a speaker and a display 110, and input components such as a keypad or a touch-sensitive screen. As described in greater detail below, the display 110 may be configured to display, among other things, a symbol set in a game.

The logic module 106 may take the form of a processor 112 and a data storage 114. The processor 114 may include a general-purpose processor (e.g., a microprocessor) and/or a special-purpose processor (e.g., a digital signal processor and/or application specific integrated circuit) and may be integrated in whole or in part with the communication interface 102 and/or the user interface 104.

The data storage 114 may include volatile and/or non-volatile storage components and may be integrated in whole or in part with the processor 112. The data storage 114 may take the form of a non-transitory computer-readable medium and may include software program instructions, that when executed by the processor 112, cause the machine 100 to perform one or more of the functions described herein.

The data storage 114 may also include operating system software on which the machine 100 may operate. For example, the machine 100 may operate on a Windows™-based operating system (e.g., Windows XP or Windows 7) provided by the Microsoft™ Corporation of Redmond, Wash.

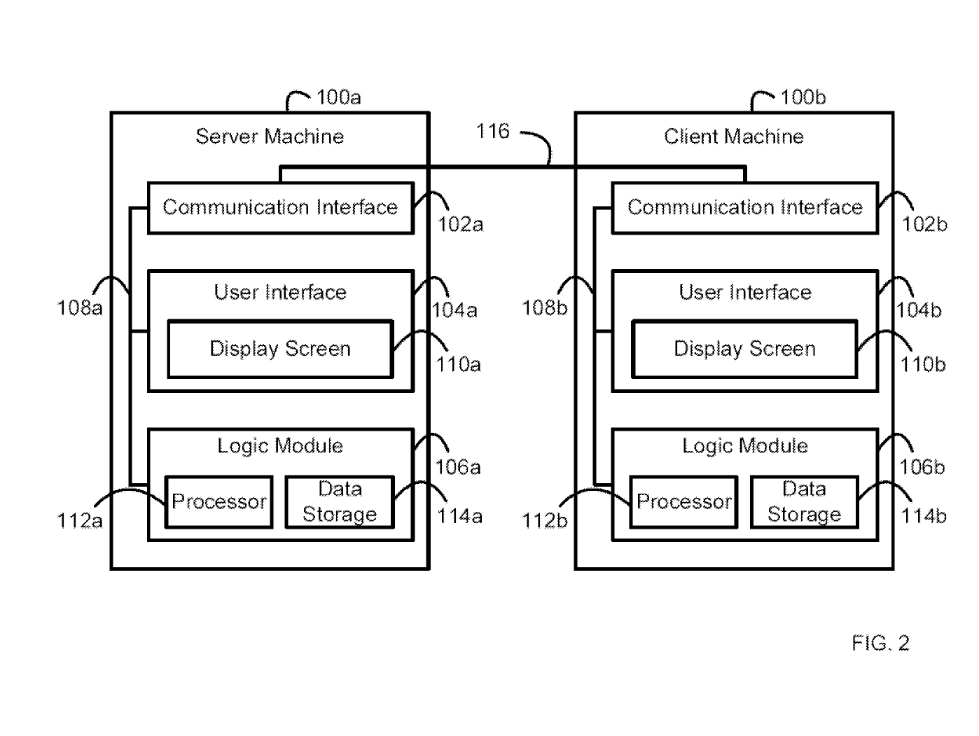

FIG. 2 is a simplified block diagram of an example server machine 100a connected to an example client machine (sometimes referred to as a workstation) 100b over a computer-network 116. The components of the server machine 100a and the client machine 100b are shown with corresponding “a” and “b” reference numerals (i.e., based on the machine 100). The server machine 100a is configured to communicate with the client machine 100b over the computer network 116 (via the communication interfaces 102a, 102b). Likewise, the client machine 100b is configured to communicate with the server machine 100a over the computer network 116. In such server-client based configurations, the server machine 100a and/or the client machine 100b may perform one or more of the functions described herein.

The computer network based server-client configuration described above may take a variety of forms. For example, the computer-network 116 may be a local area network (LAN) in a casino, such that client machines 100b dispersed throughout the casino may communicate with the server machine 100a in the casino.

In another example, the computer-network 116 may be a wide area network (WAN), such as an Internet network. In such a configuration, the client machines 100b may communicate with the server machine 100a via a website portal (for a virtual casino) hosted on the server machine 100a.

The computer-network 116 may include any of a variety of network topologies and network devices, and may employ traditional network-related technologies, including for example the public switched telephone network, cable networks, cellular wireless networks, WiFi, and WiMax. Further, the computer network may include one or more databases (e.g., a player credit account database), to allow for the storing and retrieving of data related to the game.

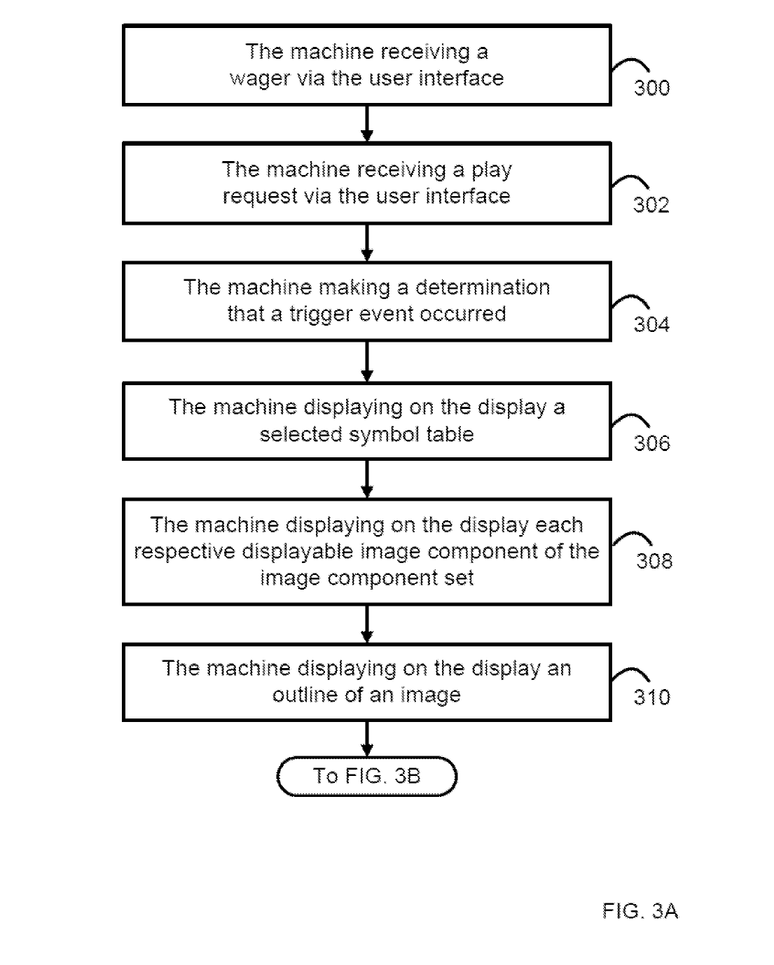

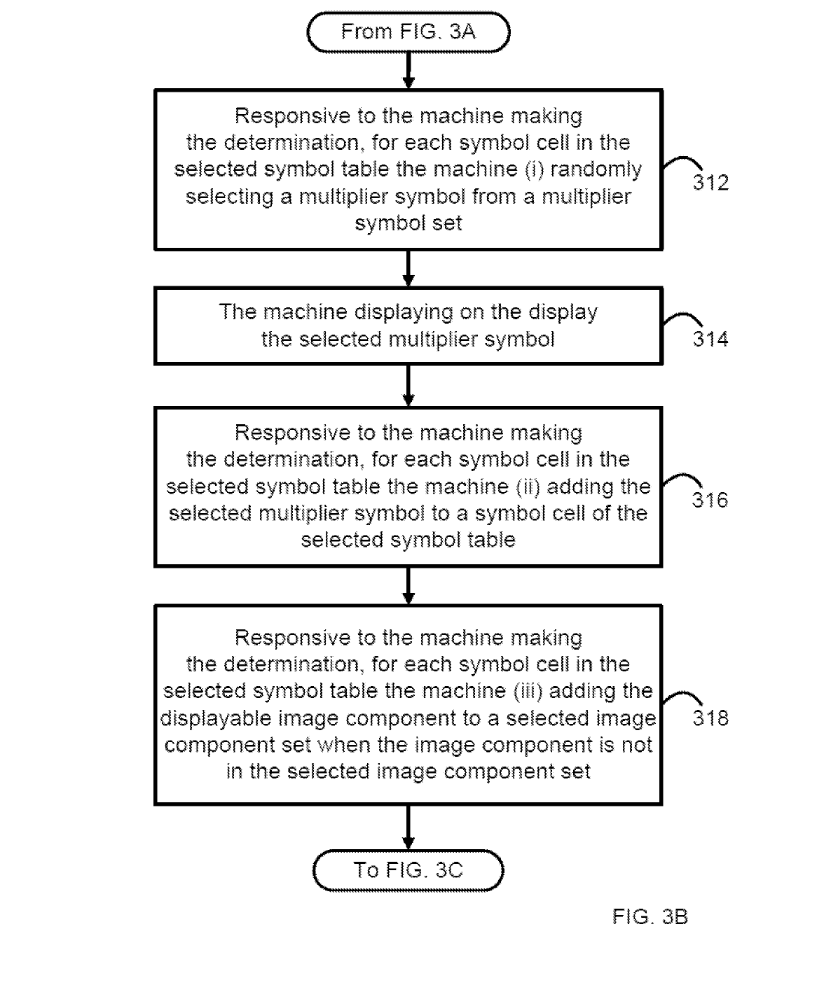

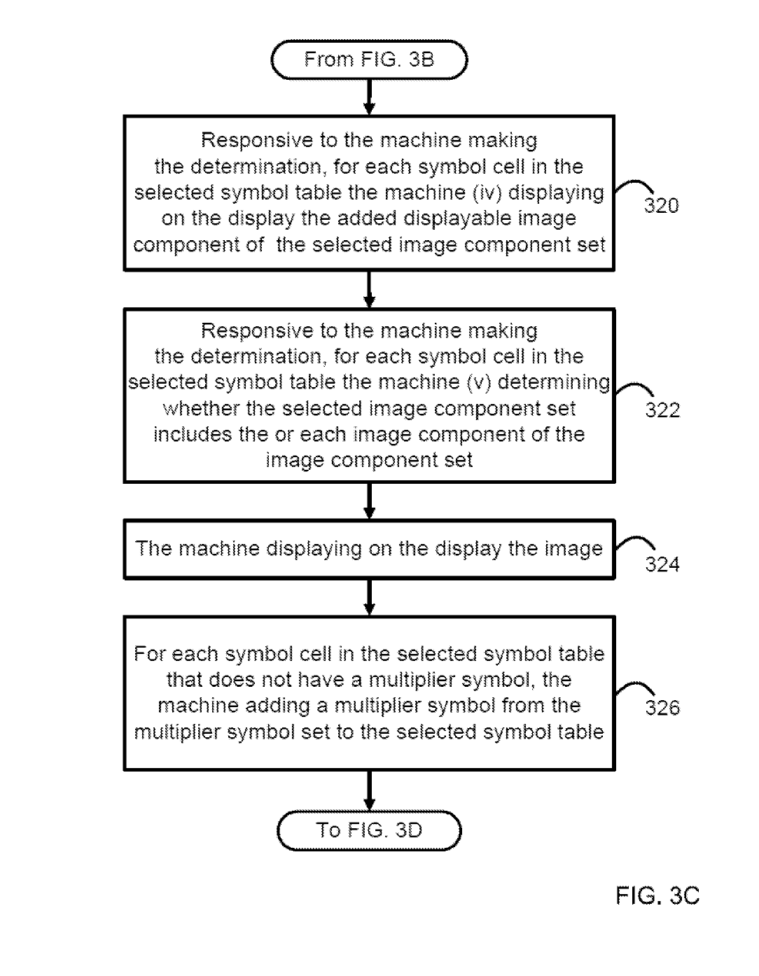

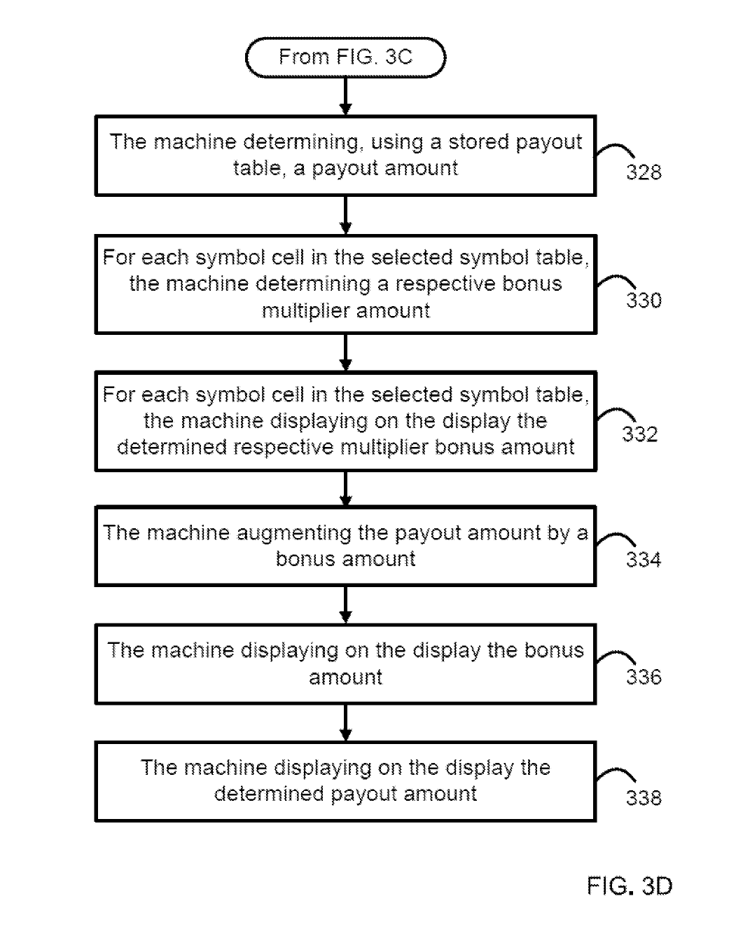

FIGS. 3A-3D show a flow chart showing functions in accordance with an example method in connection with the machine 100. The example method relates to a wager game.

At block 300, the method may involve the machine 100 receiving a wager via the user interface 104. In one example, the wager may include an amount of credits. Or, the wager may include an amount of coins, dollars, chips, or other symbols of value. In one example, receiving a wager may allow a player to enter a wager of the wager game on a keypad on the machine 100. In one example, a player may have a corresponding player credit balance from which the wager may be deducted in response to the machine 100 receiving a play request from the player. For example, a player may have a player credit balance of 100,000, which may be reduced to 99,750 credits upon the player requesting a play of the game with a wager of 250 credits. In one example, the method may further involve the machine 100 displaying on the display 110 the player credit balance and/or the wager amount.

At block 302, the method may involve the machine 100 receiving a play request (e.g., a “spin” request) via the user interface 104. In one example, this may allow a player to pull a level or push a button on the machine 100 to request a play of the wager game. Or, in some embodiments, this may allow a player to roll a die on the machine 100 to request a play of the wager game. As noted above, this may result in the player's credit balance being reduced by the player's wager.

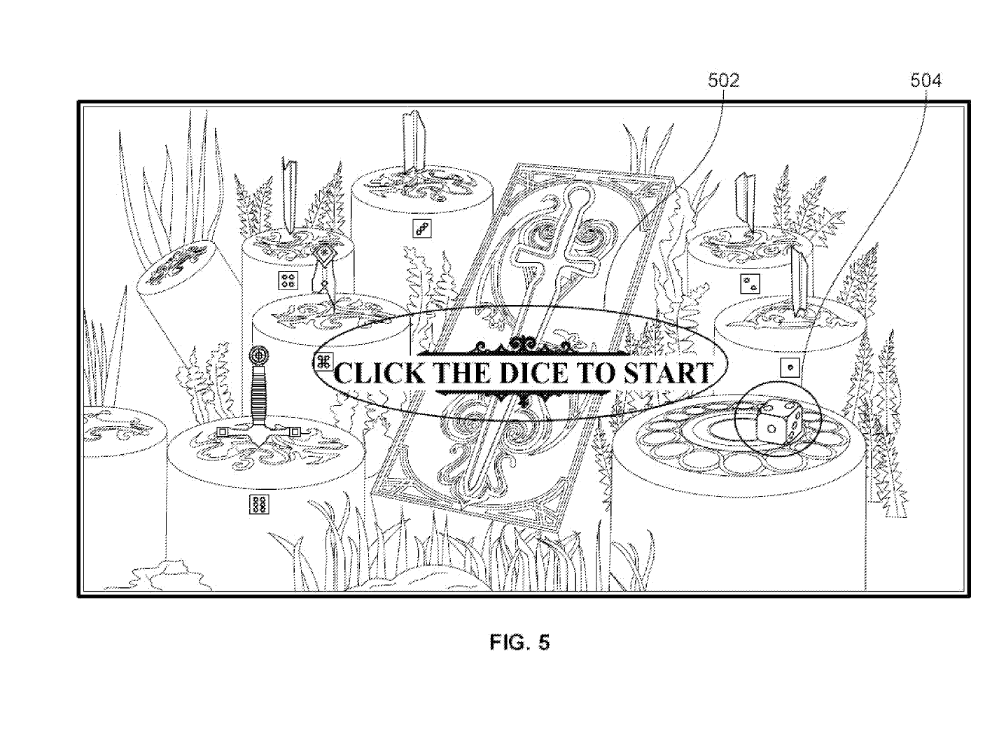

FIG. 5 shows an example of an indication of a play request 502 and a die 504 to invoke a play request displayed on a display 110. In this embodiment, when the player clicks the die 504, the machine 100 receives a play request. Note that while in this example, play request 502 indicates to the player to click on the dice to start, play request 502 can alternatively indicate to the player to click on a die to start. Moreover, as shown in this example, the die 504 may include one die, or, in some embodiments, the die 504 may include multiple dice. Likewise, the play request can take other forms, as well.

At block 304, the method may involve the machine 100 making a determination that a trigger event occurred. The trigger event may be a randomly occurring event. For example, the trigger event occurring may involve the machine 100 selecting a trigger symbol from a group of symbols, such as in connection with a previous play of the game. In another example, the trigger event occurring may involve the machine 100 selecting a trigger symbol for display in a particular arrangement position (e.g., in a middle row or a middle column). As yet another example, the trigger event may involve the machine 100 selecting, using a random number generator, a number in response to the machine 100 receiving the play request, where the selected number is a trigger number. Note that while a few example trigger events have been described above, any of a variety of other trigger events could be used to suit a desired configuration.

At block 306, the method may involve the machine 100 displaying on the display 110 a selected symbol table. The selected symbol table may comprise a plurality of symbol cells. For example, the selected symbol table may contain ten symbol cells.

Each symbol cell may indicate to the player a respective chance. Each respective chance may indicate an opportunity for an image component to be added to a selected image component set.

The symbol cells may be configured such that a multiplier symbol may be added to a symbol cell. Each symbol cell may be empty or may contain a multiplier symbol. In some embodiments, each symbol cell may be initially empty and then one or more of the symbol cells may later contain a multiplier symbol that has been added to the symbol cell.

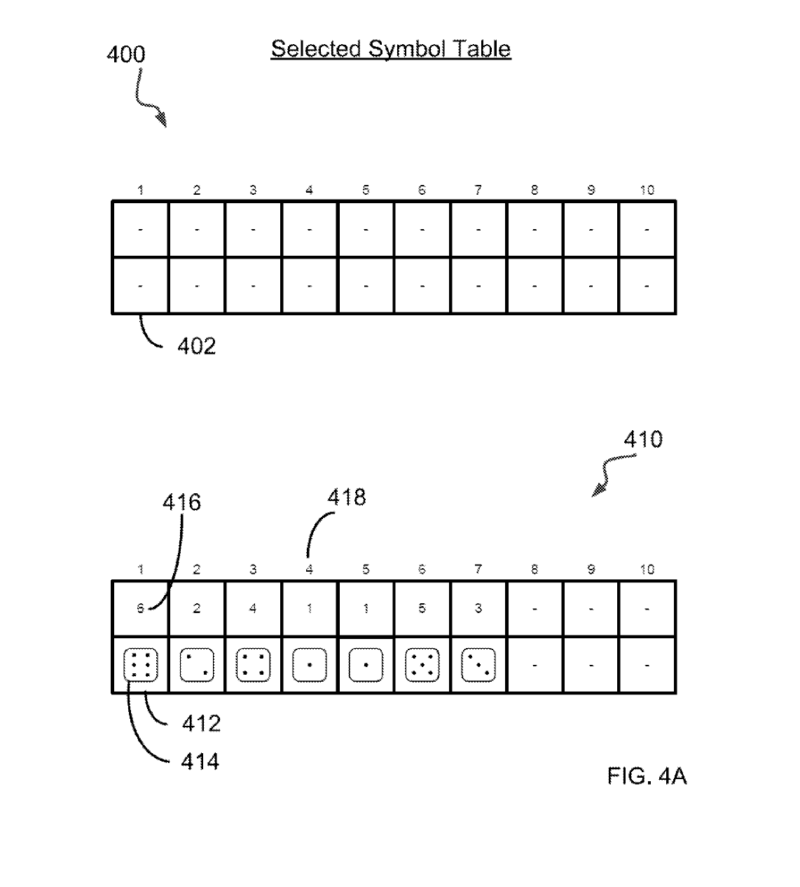

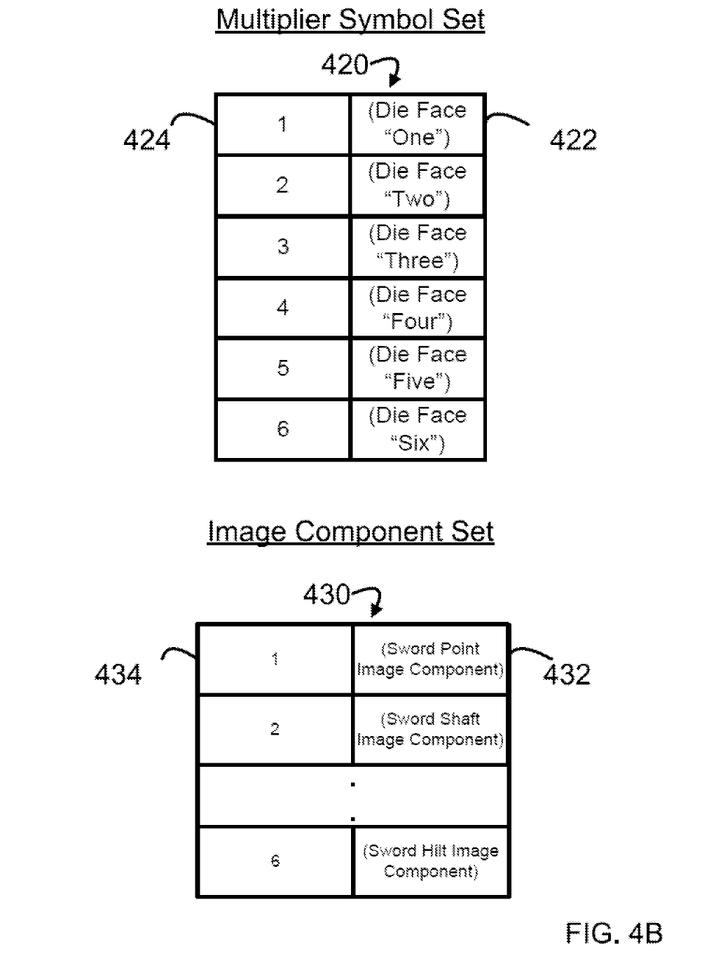

FIG. 4A shows an example of a selected symbol table 400 having a symbol cell 402 that is empty. Symbol cell 402 may contain a multiplier symbol that has been added to the symbol cell. Such indication of a multiplier symbol may be an image component that corresponds to the multiplier symbol.

FIG. 4A also shows a second example embodiment of a selected symbol table 410 having a symbol cell 412 that contains a representation of a multiplier symbol 414. In this second example embodiment, the representation of the multiplier symbol 414 is a die face having six dots. Each multiplier symbol in the selected symbol table 410, such as multiplier symbol 414, may correspond to an index, such as index 416. The index may assist in operations involving the multiplier symbol 414.

Each symbol cell in the selected symbol table 410 may also include a cell index, such as cell index 418. The index may assist in operations involving the particular symbol cells.

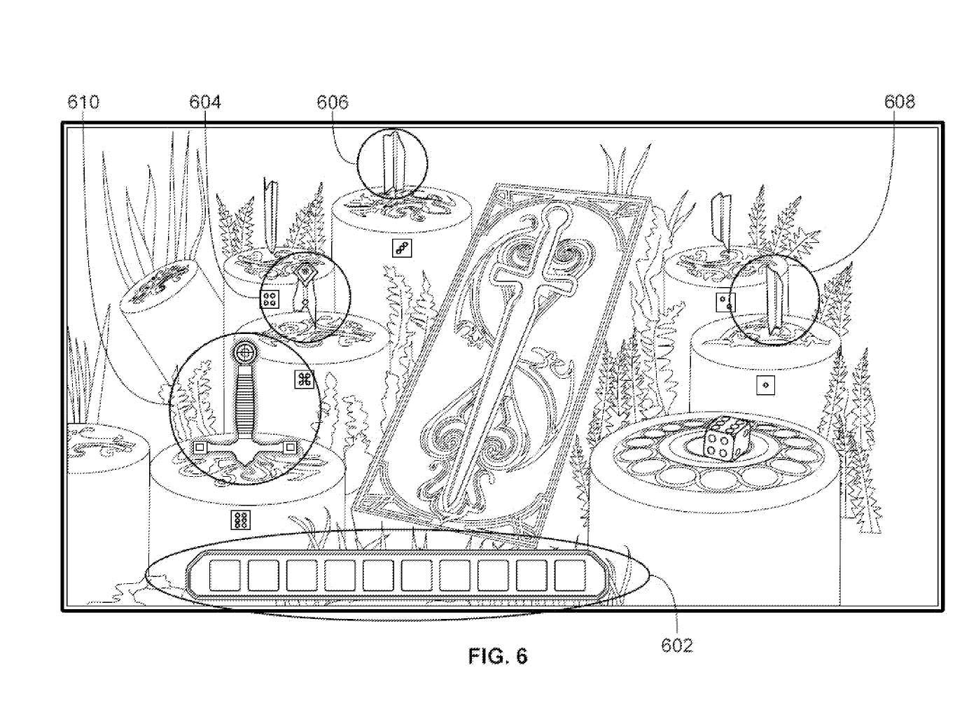

FIG. 6 shows an example of a selected symbol table 602 displayed on a display 110. As shown, the selected symbol table 602 includes a plurality of symbol cells that may contain multiplier symbols.

At block 308, the method may involve the machine 100 displaying on the display 110 each respective image component of the image component set. Each image component of the image component set may correspond to a part of an image. The image component set may correspond to an image, such that each image component of the image component set may be combined with the other image components of the image component set to form the image. For example, the image may show a sword and each image component may correspond to a fragment of the sword. The image components, or sword fragments, may be combined to form the sword image. Images of other subject matter are possible as well.

FIG. 4B shows an example embodiment of an image component set 430 that includes an image component 432. In this example embodiment, the image is of a sword. Image component 432 corresponds to a “sword point.” Other image components are part of the set, such as the “sword shaft” and “sword hilt,” as shown. Image component 432 may correspond to an index 434 such that the image component may be matched to a multiplier symbol.

FIG. 6 further shows examples of image components 606, and 608, among other image components, as shown. In this example, each of image components 604, 606, and 608 are part of a sword image.

In another example, each image component of the image component set may be an image of a color band of a rainbow. One image component might be a red band, and other image component might be an orange band, a yellow band, a green band, a blue band, an indigo band, and a violet band.

At block 310, the method may involve the machine 100 displaying on the display 110 an outline of the image. Each selected image component may be placed within the outline to indicate to the players which image components have already been selected. Further, the outline may indicate to the player which image components have yet to be selected because a respective empty space may be left within the outline that corresponds to each image component that has not been selected.

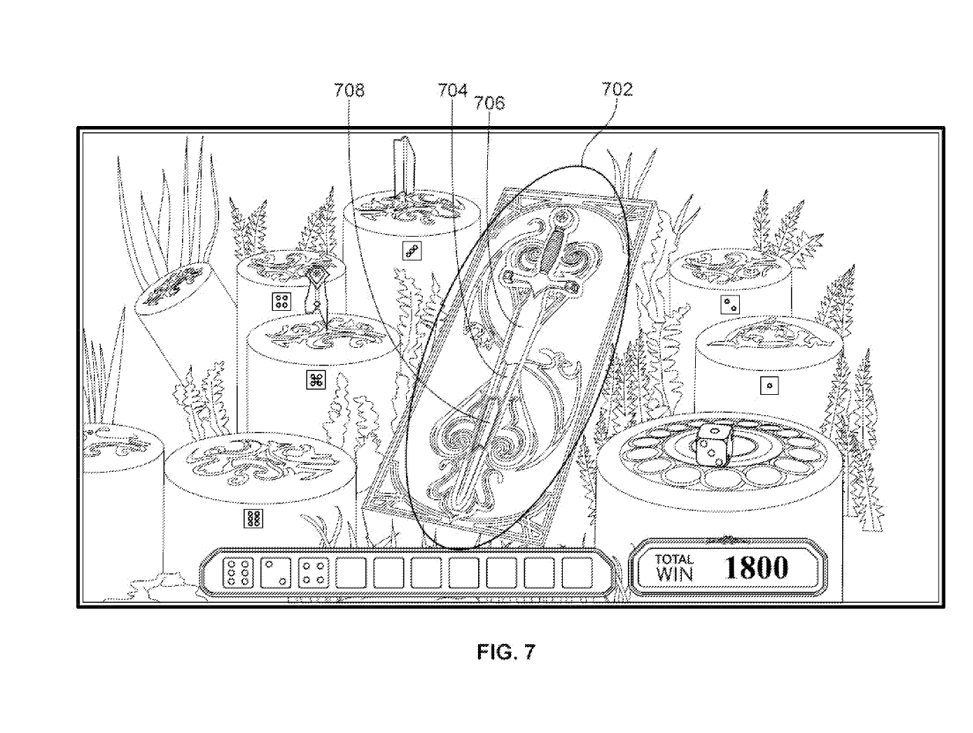

FIG. 7 shows an example of an outline 702 that may displayed on a display, such as display 110 in FIG. 1. In this example, the outline is of a sword image. The outline 702 shows image component 704 that has been placed within the outline to indicate that image component 704 has been selected. Outline 702 also shows an empty space 706 within the outline that may indicate to the player an image component that has not yet been selected.

Referring to the example where each image component is a color band of a rainbow, the outline may be of a rainbow image. Each image component (color band) may be placed within the outline until an image of a rainbow is composed.

In some embodiments, the machine may iterate through each symbol cell in the selected symbol table. In one embodiment, various functions are performed during each iteration, for a symbol cell, before proceeding to the next iteration, for the next symbol cell. For example, the machine may perform functions including block 312, block 314, block 316, block 318, block 320, and block 322 for a particular symbol cell during an iteration, before proceeding to another iteration involving a different symbol cell. Other embodiments may involve performing, during an iteration, none, all, or any combination of blocks 312-322, as well as other functions.

At block 312 in FIG. 3B, the method may involve, responsive to making the determination (that a trigger event occurred), for each symbol cell in the selected symbol table, the machine 100 randomly selecting a multiplier symbol from a multiplier symbol set. Randomly selecting a multiplier symbol may correspond to rolling a die to determine which side lands up on the die or spinning a spinner to determine which slot on the spinner that the spinner marker lands on. The machine performs and/or simulates rolling a die or spinning a spinner. Other types of random selection are possible as well.

In some embodiments, the selected multiplier symbol corresponds to a displayable image component. Each multiplier symbol may correspond to a particular displayable image component. For example, multiplier symbol 422 in FIG. 4B having index 424 indicating a “1” may correspond to image component 432 having index 434 also indicating a “1”. In this arrangement, the multiplier symbol 422 corresponds to a particular displayable image component 434 by sharing a common index.

In some embodiments, the displayable image component may be from an image component set. Further, the image component set may correspond to an image. As described above, each image component of the image component set may correspond to a part of the image. The image component set may correspond to the image, such that each image component of the image component set may be combined with the other image components of the image component set to form the image.

In some embodiments, each image component of the image component set may appear as a fragment of the image. In this arrangement, the image appears to be broken apart into the respective fragments.

FIG. 4B shows an example embodiment of a multiplier symbol set 420 having a multiplier symbol 422. In this example embodiment, multiplier symbol 422 indicates die face “one,” a specific face of a die. Other multiplier symbols in the multiplier symbol set may indicate other faces of the die, such as die face “two”, die face “three”, die face “four”, die face “five” or die face “six,” as shown. In one embodiment, multiplier symbol 422 corresponds to an index 424 so that each multiplier symbol can be matched to a corresponding image component.

In one embodiment, the machine randomly selecting a multiplier symbol may correspond to randomly selecting a face of a die. In some embodiments, when the machine randomly selects a multiplier symbol, an indication of a rolling die may be displayed on a display to indicate the random selection of multiplier symbols to the user.

In another example embodiment, each respective multiplier symbol in the multiplier symbol set may correspond to a respective slot on a spinner. In such embodiment, randomly selecting a multiplier symbol may correspond to randomly selecting a slot on a spinner. In some embodiments, when the machine randomly selects a multiplier symbol, an indication of a spinning spinner may be displayed on a display to indicate the random selection to the user.

Each multiplier symbol may be associated with a respective multiplier. For example, a multiplier symbol that is die face “six” may be associated with a “6” multiplier. Or, as another example, a multiplier symbol on a spinner that is a “five hundred” slot may be associated with a “500” multiplier, or some factor thereof, such as 5, 50, or 5000.

In some embodiments, the multiplier symbol set may include an amount of multiplier symbols. For example, the amount of multiplier symbols in multiplier symbol set 420 is six. This amount of multiplier symbols may be referred to as a first amount. As described above, the selected symbol table may include a plurality of symbol cells. The plurality may include an amount of symbol cells. For example, the amount of symbol cells in selected symbol set 410 is ten. This amount of symbol cells may be referred to as a second amount. In some embodiments, the second amount may be greater than the first amount. This arrangement may encourage the player to play the wager game.

In some embodiments, block 312 may involve the machine 100 making a second determination that a second trigger event occurred, and responsive to the second determination, randomly selecting a multiplier symbol from the multiplier symbol set. In some embodiments, the second trigger event may correspond to rolling a die. In other embodiments, the second trigger event may correspond to spinning a spinner. In further embodiments, the second trigger event may correspond to a player selecting on a user interface an indication of a die, so as to roll the die. Or, in other embodiments, the second trigger event may correspond to a player selecting on a user interface an indication of a spinner so as to spin the spinner. Such a second trigger event may indicate to the player that they are initiating the random selection of the multiplier symbol. This arrangement may increase a player's interaction with the game which may encourage the player to play the wager game. Other examples of second trigger events are possible as well.

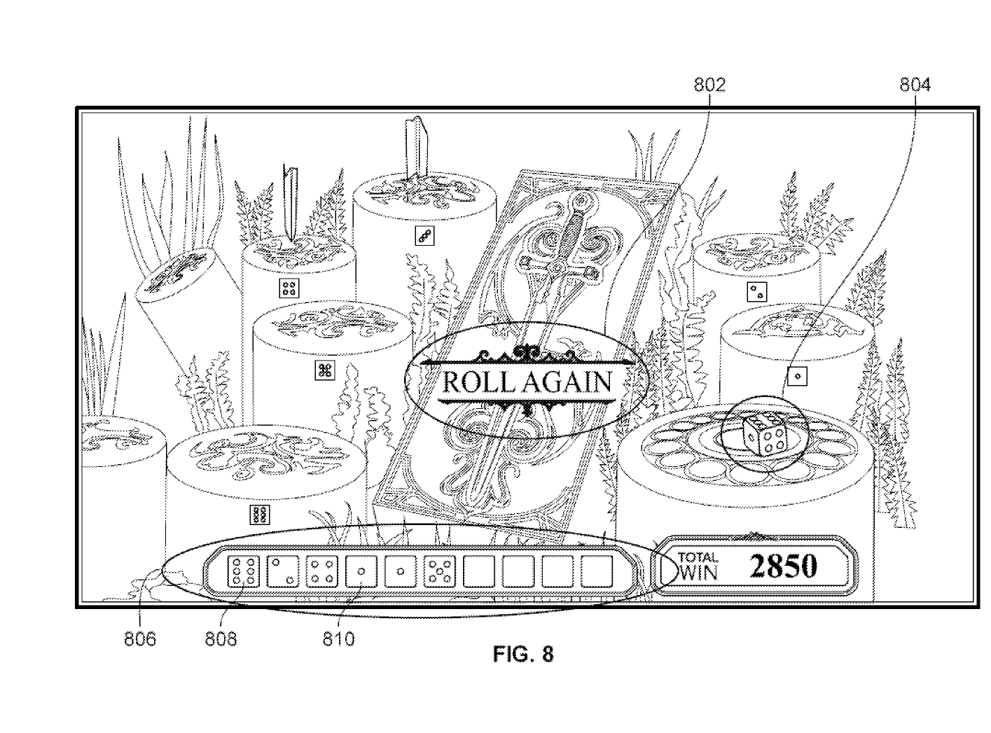

FIG. 8 shows an example of an indication 802 that the machine is ready to make a determination that a second trigger event occurred that may be displayed on the display 110. A die 804 is displayed on the user interface 800. When the player clicks the die 804, the machine determines that the second trigger event occurred.

In further embodiments, block 312 may involve the machine 100 using a random number generator to select numbers from a set of numbers to select multiplier symbols corresponding with the selected numbers. For example, where the multiplier symbol set has six multiplier symbols, a random number generator might generate indications of numbers 1-6 which correspond to indices in the multiplier symbol set that respective indicate certain multiplier symbols.

As further example, a random number generator might generate a “1.” The “1” matches index “1” in multiplier symbol set 420 that indicates multiplier symbol 422. As a result, in this example, multiplier symbol 422 is randomly selected using the random number generator. Other arrangements in which a random number generator is used to select numbers from a set of numbers to select multiplier symbols corresponding with the selected numbers are possible as well.

Returning to FIG. 3B, at block 314, the method may involve the machine 100 displaying on the display 110 the selected multiplier symbol. This step may indicate to the player which multiplier symbol was randomly selected. For example, when multiplier symbol 422 is selected, die face “one” may be presented to the user. In some embodiments, displaying on the display the selected multiplier symbol may involve displaying a representation of the multiplier symbol. For example, when multiplier symbol 422 is selected, an image of die face “one” may be presented to the user.

At block 316, the method may involve, responsive to making the determination (that a trigger event occurred), for each symbol cell in the selected symbol table, the machine 100 adding the selected multiplier symbol to a symbol cell of the selected symbol table. The selected symbol cell may be added to an empty symbol cell. As each respective selected multiplier is added to the selected symbol table, the symbol cells of the selected symbol table will fill up with multiplier symbols.

Returning to FIG. 8, display 800 further shows multiplier symbols 808, and 810 that have been added to selected symbol table 806. As shown, multiplier symbols 808 and 810 are die faces.

This arrangement may allow the selected symbol table to indicate to the player how many multiplier symbols have been selected, which multiplier symbols have been selected, or how many further multiplier cells may be selected, among other possibilities. For example, in FIG. 8, selected symbol table 806 has ten symbol cells. Six multiplier symbols have been selected; they are die face “six”, die face “two”, die face “four”, die face “one”, die face “one” and die face “five”. Four empty symbol cells remain indicating that up to four more multiplier symbols may be selected.

As further shown in FIG. 8, each multiplier symbol may be selected more than once, such that the selected symbol table includes more than one instance of each multiplier symbol. For example, two instances of multiplier symbol 810 that are die face “one” have been added to selected symbol table 806.

At block 318 in FIG. 3B, the method may involve, responsive to making the determination (that a trigger event occurred), for each symbol cell in the selected symbol table, the machine 100 adding the displayable image component to a selected image component set when the image component is not in the selected image component set.

The added displayable image component corresponds to the selected multiplier symbol. As described above, each image component corresponds to a multiplier symbol. To correspond with a multiplier symbol, each image component may have an index that matches the index of a particular multiplier symbol.

Adding the displayable image component to the selected image component set depends on whether the displayable image component is already in the selected image component set. If the displayable image component is already in the selected image component set, then the displayable image component is not added to the selected image component set. However, if the displayable image component is already in the selected image component set, then the displayable image component is added to the selected image component set. The selected image component set may include up to one instance of each selected image component from the image component set.

Turning to FIG. 3C, at block 320, the method may involve responsive to making the determination (that a trigger event occurred), for each symbol cell in the selected symbol table, the machine 100 displaying on the display 110 the added displayable image component of the selected image component set.

As described above, in some embodiments, the machine 100 may display on the display 110 the added displayable image component within an outline of the image. The added displayable image may be arranged within the outline so if the other displayable image components of the image components set are also arranged within the outline, the outline is filled in with displayable image components to compose the image.

In some embodiments, portions of the outline of the image may correspond to one or more indices that correspond to image components of the image component set. For example, index 434 corresponding to image component 432 may also correspond to the sword point portion of the outline of the image. This may allow the machine to arrange the image components within the outline such that the displayable image components compose the image.

Referring to the example where each image component is a color band of a rainbow, portions of the outline of the rainbow image may correspond to one or more indices that correspond to image components of the image component set. In such embodiments, the one or more indices may allow the machine to arrange the image components (color bands) in the order from red, to orange, to yellow, to green, to blue, to indigo, and to violet (i.e. ROYGBIV).

In some embodiments, the machine displaying on the display the added image component of the selected image component set may comprise highlighting the added image component. In one example, the machine 100 may highlight such an added image component by highlighting, shading, hatching or adding a border around the symbols, but other indication techniques may be used.

Referring back to FIG. 7, FIG. 7 shows an example of added image component 708 of the selected image component set that may be displayed on a display, such as display 110 of FIG. 1. As a further example, added image component 708 in FIG. 7 is highlighted by changing the color of the added image component, as shown.

At block 322 in FIG. 3C, the method may involve responsive to making the determination (that a trigger event occurred), for each symbol cell in the selected symbol table, the machine 100 determining whether the selected image component set includes the or each image component of the image component set. The machine 100 may compare the image components in the image component set to the image components in the selected image component set determine whether each image component in the image component set is also in the selected image component set.

The machine 100 may use an index associated with each image component to make the determination. For example, image component set 430 in FIG. 4B includes images components having indices 1-6. The machine may determine whether the selected image component set includes an added image component with index 1, an added image component with index 2, an added image component with index 3, an added image component with index 4, an added image component with index 5, and an added image component with index 6 such that each image component in the image component set is also in the selected image component set.

In some embodiments, one goal of the wager game may be to add every image component of the image component set to the selected image component set by selecting each multiplier symbol from the multiplier symbol set.

At block 324, the method may involve the machine 100 displaying the image when the selected image component set includes the or each image component of the image component set. The image may be composed of the or each respective displayable image component of the selected image component set. Displaying the image may indicate to the player that the image has been completed and one goal of the game completed. This arrangement may encourage the player to play the game.

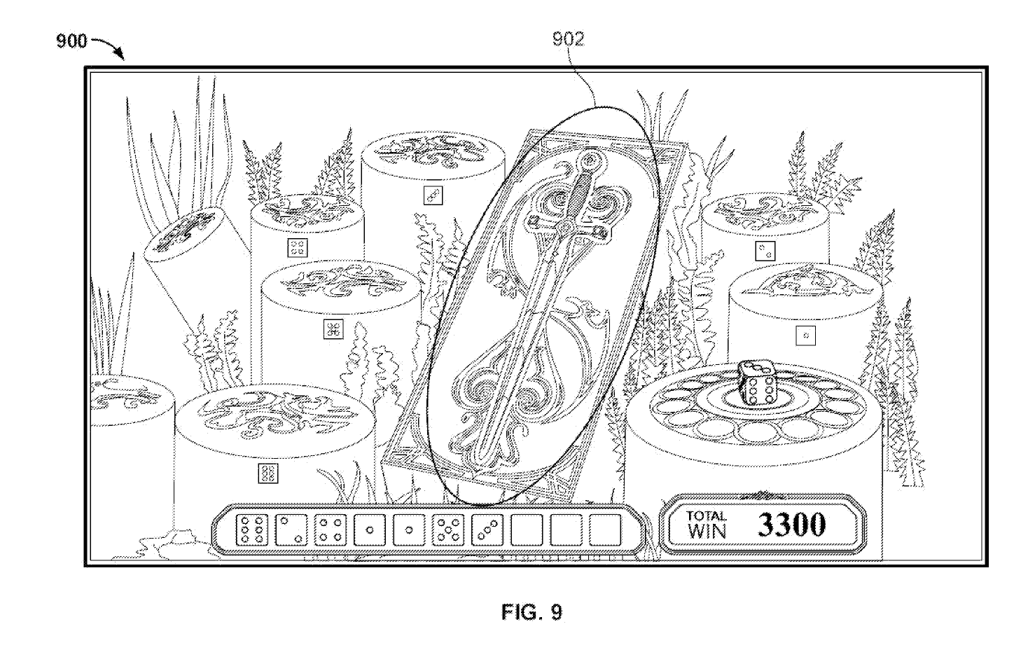

FIG. 9 shows an example of an image 902 that may be displayed on a display, such as display 110.

Returning to FIG. 3C, at block 326, the method may involve, for the or each symbol cell in the selected symbol table that does not have a multiplier symbol, the machine 100 adding a multiplier symbol from the multiplier symbol set. In some embodiments, the multiplier symbol added may be the multiplier symbol in the multiplier symbol set having the highest corresponding multiplier. For example, if the multiplier symbol set has multiplier symbol die face “one” through die face “six” having corresponding multipliers 1-6 respectively, the added multiplier symbol may be die face “six.” Other added multiplier symbols are possible as well.

Turning to FIG. 3D, at block 328, the method may involve the machine 100 determining, using a stored payout table, a payout amount. In some embodiments, the payout amount may be a function of at least the received wager and one or more respective multipliers that are associated with the or each respective selected multiplier symbol.

At block 330, the method may involve, for the or each selected multiplier symbol in the selected symbol table, the machine 100 determining a respective multiplier bonus amount, wherein the multiplier bonus amount is a function of the respective multiplier and the wager.

For example, the selected symbol table may include the following ten multiplier symbols: die face “six”, die face “two”, die face “four”, die face “one”, die face “one”, die face “five”, die face “three”, die face “six”, die face “six”, and die face “six.” These ten multiplier symbols in the selected symbol table may be associated with the following multipliers: 6, 2, 4, 1, 1, 5, 3, 6, 6, and 6, respectively. Each respective bonus amount may be determined by multiplying the wager by the respective multiplier. As described above, the wager may include, as some examples, credits, coins, chips, or dollars, among other possibilities. For example, if the wager is 150 credits, one respective multiplier bonus amount is 150 credits multiplied by 6, or 900 credits. Another example of a respective bonus amount is 150 credits multiplied by 2, or 600 credits.

In some embodiments, the payout amount is the sum of the respective bonus amounts. For example, using the example respective bonus amounts described above, the payout amount may be the sum of 900 and 600 which sums to 1500. Other examples of payout amounts calculated with fewer or more respective bonus amounts are possible.

At block 334, the method may involve the machine 100 augmenting the payout amount by a bonus amount when the selected image component set includes each image component of the image component set. Augmenting the payout amount may provide incentive to the player to complete the image, which, as described above, may be one goal of the wager game.

At block 336, the method may involve the machine 100 displaying on the display the bonus amount. Displaying on the display the bonus amount may indicate to the player that the payout amount was augment by a bonus amount.

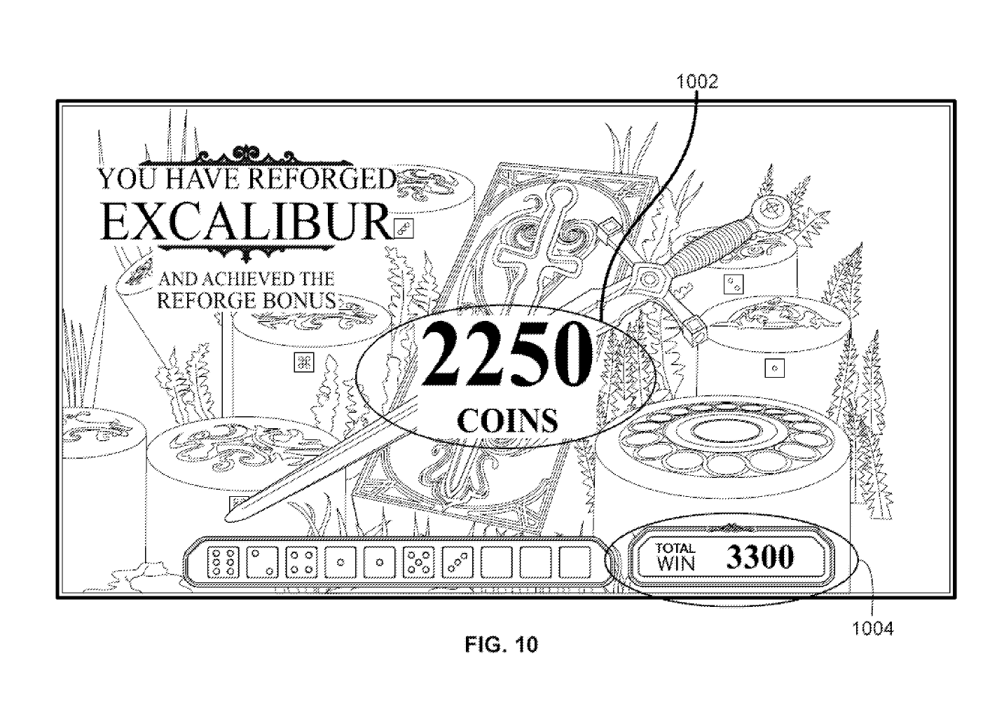

FIG. 10 shows an example of a bonus amount 1002 that may be displayed on a display, such as display 110 in FIG. 1.

At block 338, the method may involve the machine 100 displaying on the display the determined payout amount. In some embodiments, block 338 may be performed repeatedly which may keep the player apprised of the payout amount that has been accumulated. In further embodiments, block 338 may be performed once to apprise the player of the payout amount. Other combinations are possible as well.

FIG. 10 shows an example embodiment of a user interface 1000 that shows the determined payout amount 1004. User interface 1000 may be displayed on a display, such as display 110 in FIG. 1.

In some embodiments, the determined payout amount may be credited to a player account, a player card, or a player wallet. The determined payout amount may increase the amount of credits, coins, chips, dollars, or other value symbols in the player account, the player card, or the player wallet.

In some embodiments, the game feature described above may be one of multiple game features of a given game. In some instances, the machine 100 may make a determination that a trigger event occurred (e.g., based on a random selection as described above). And in response to making the determination, the machine 100 may randomly select a game feature from a group of game features. Further, in response to selecting the game feature, the machine may perform the appropriate steps to execute the selected game feature. For example, where the game feature is the one described above, in response to selecting the game feature, the machine 100 may make the determination as described above at block 300, and then perform one or more of the other functions described herein in connection with FIGS. 3A-3D to execute the game feature. Note that the group of game features may include a variety of different types of game features.

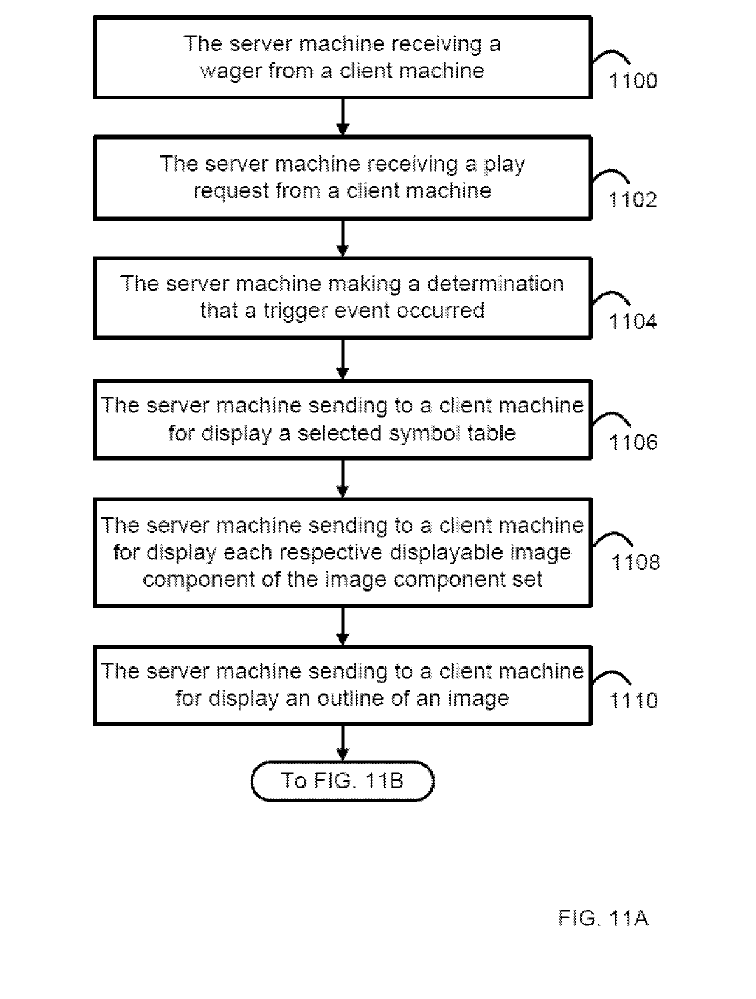

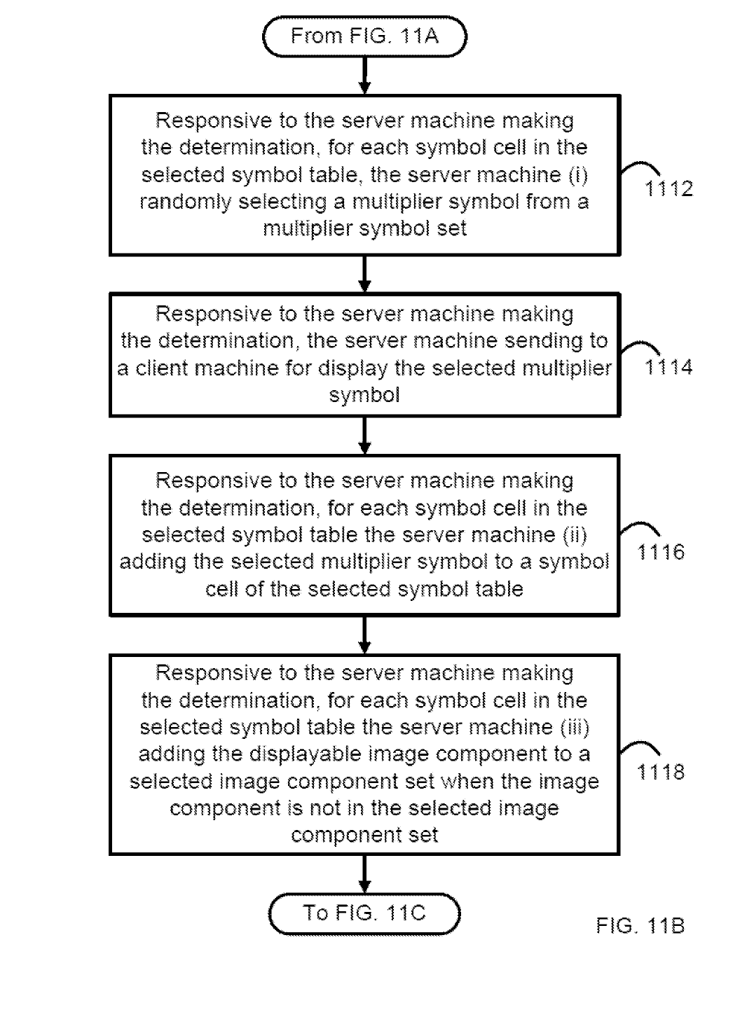

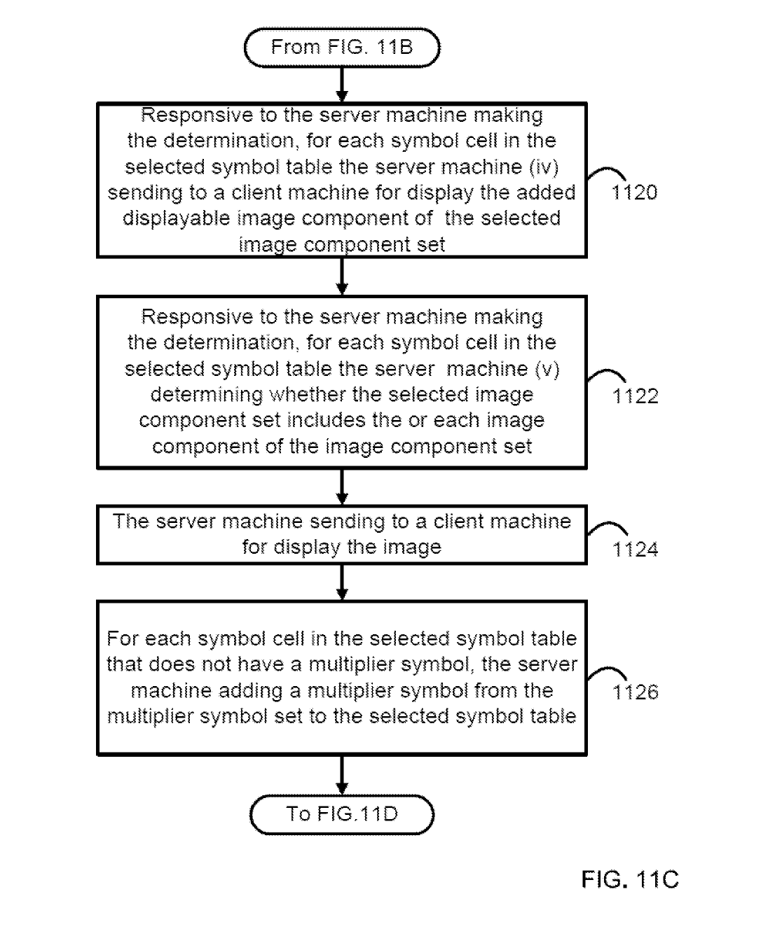

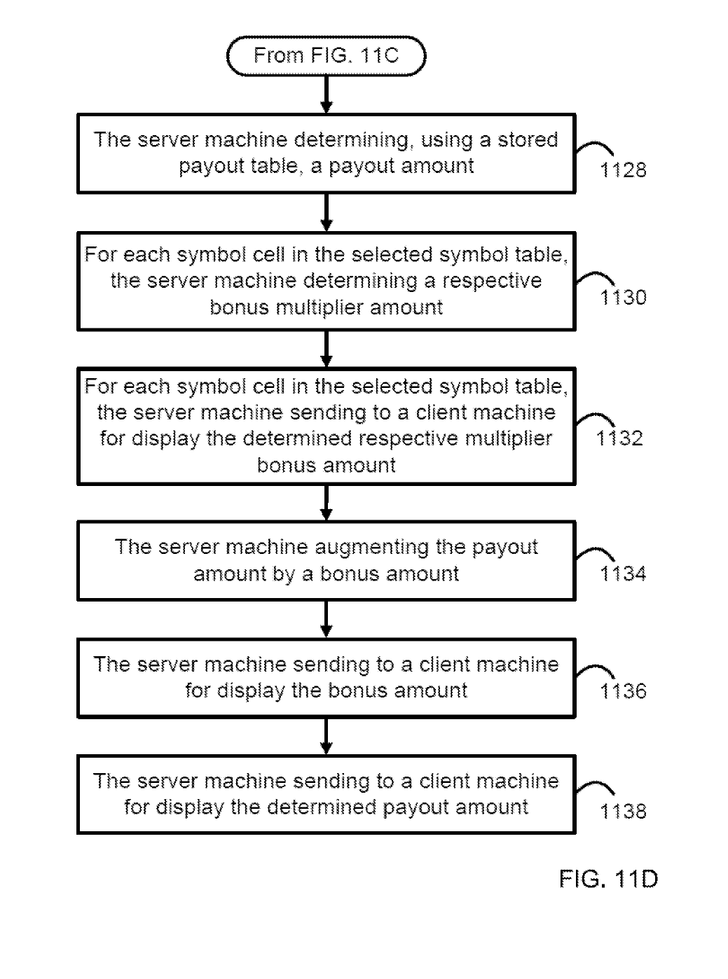

FIGS. 11A-11D show a flow chart showing functions in accordance with an example method in connection with the server machine 100a. Note that several of the functions described in connection with FIGS. 11A-11D parallel functions described in connection with FIGS. 3A-3D. As such, variations of the functions described in connection with FIGS. 3A-3D are likewise applicable to the functions described in connection with FIGS. 11A-11D. However, for the sake of brevity, these variations are not repeated.

At block 1100, the method may involve the server machine 100a receiving a wager from the client machine 100b.

At block 1102, the method may involve the server machine 100a receiving a play request from the client machine 100b.

At block 1104, the method may involve the server machine 100a making a determination that a trigger event occurred.

At block 1106, the method may involve the server machine 100a sending to a client machine for display a selected symbol table comprising a plurality of symbol cells.

At block 1108, the method may involve the server machine 100a sending to the client machine for display the or each respective displayable image component of the image component set.

At block 1110, the method may involve the server machine 100a sending to the client machine for display an outline of the image.

Turning to FIG. 11B, at block 1112, the method may involve, responsive to the server machine 100a making the determination, the server machine, for each symbol cell in the selected symbol table, randomly selecting a multiplier symbol from a multiplier symbol set.

In one embodiment, various functions are performed during each iteration, for a symbol cell, before proceeding to the next iteration, for the next symbol cell. For example, the machine may perform functions including block 1112, block 1114, block 1116, block 1118, block 1120, and block 1122 for a particular symbol cell during an iteration, before proceeding to another iteration involving a different symbol cell. Other embodiments may involve performing, during an iteration, none, all, or any combination of blocks 1112-1122, as well as other functions.

At block 1114, the method may involve, responsive to the server machine 100a making the determination, the server machine, for each symbol cell in the selected symbol table, sending to the client machine for display the selected multiplier symbol.

At block 1116, the method may involve, responsive to the server machine 100a making the determination, the server machine, for each symbol cell in the selected symbol table, adding the selected multiplier symbol to a symbol cell of the selected symbol table.

At block 1118, the method may involve, responsive to the server machine 100a making the determination, the server machine, for each symbol cell in the selected symbol table, adding the displayable image component to a selected image component set when the image component is not in the selected image component set.

Turning to FIG. 11C, at block 1120, the method may involve, responsive to the server machine 100a making the determination, the server machine, for each symbol cell in the selected symbol table, sending to the client machine for display the added displayable image component of the selected image component set.

At block 1122, the method may involve, responsive to the server machine 100a making the determination, the server machine, for each symbol cell in the selected symbol table, determining whether the selected image component set includes the or each image component of the image component set.

At block 1124, the method may involve, the server machine 100a sending to the client machine for display the image, wherein the image is composed of the or each respective displayable image component of the selected image component set when the selected image component set includes the or each image component of the image component set.

At block 1126, the method may involve the server machine 100a, for the or each symbol cell in the selected symbol table that does not have a multiplier symbol, adding a multiplier symbol from the multiplier symbol set to the selected symbol table when the selected image component set includes each image component of the image component set.

Turning to FIG. 11D, at block 1128, the method may involve the server machine 110a determining, using the stored payout table, a payout amount, wherein the payout amount is a function of at least the received wager and one or more respective multipliers that are associated with the or each respective selected multiplier symbol.

At block 1130, the method may involve the server machine 100a, for the or each symbol cell in the selected symbol table, determining a respective multiplier bonus amount, wherein the multiplier bonus amount is a function of the respective multiplier and the wager.

At block 1132, the method may involve the server machine 100a, for the or each selected multiplier symbol in the symbol table, sending to the client machine for display the determined respective multiplier bonus amount.

At block 1134, the method may involve the server machine 100a augmenting the payout amount by a bonus amount when the selected image component set includes each image component of the image component set.

At block 1136, the method may involve the server machine 100a sending to the client machine for display the bonus amount.

At block 1138, the method may involve the server machine 100a sending to the client machine for display the determined payout amount.

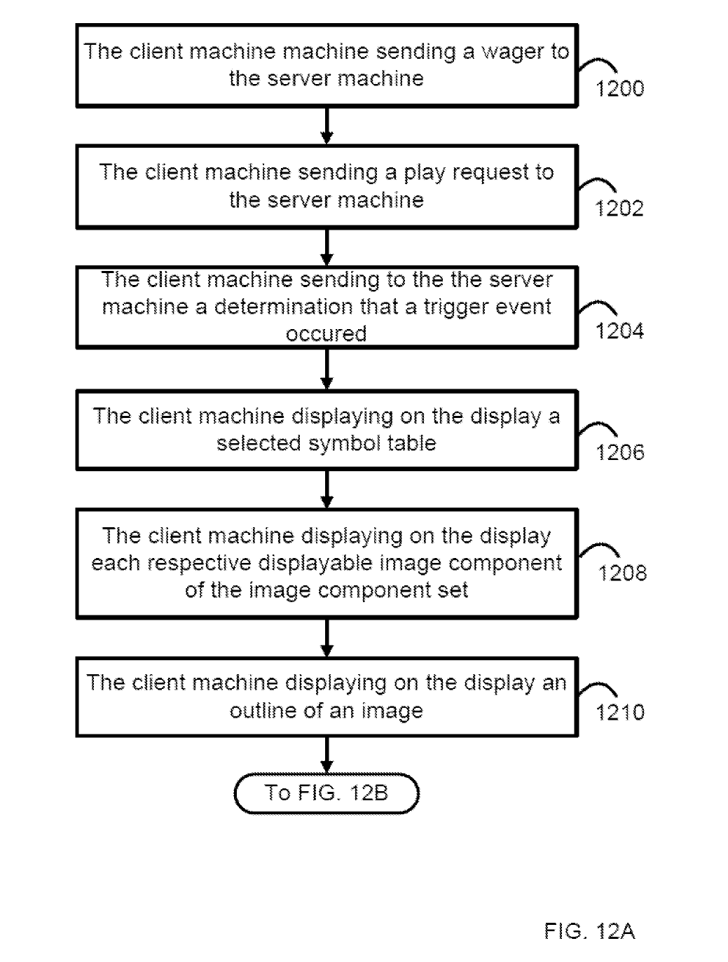

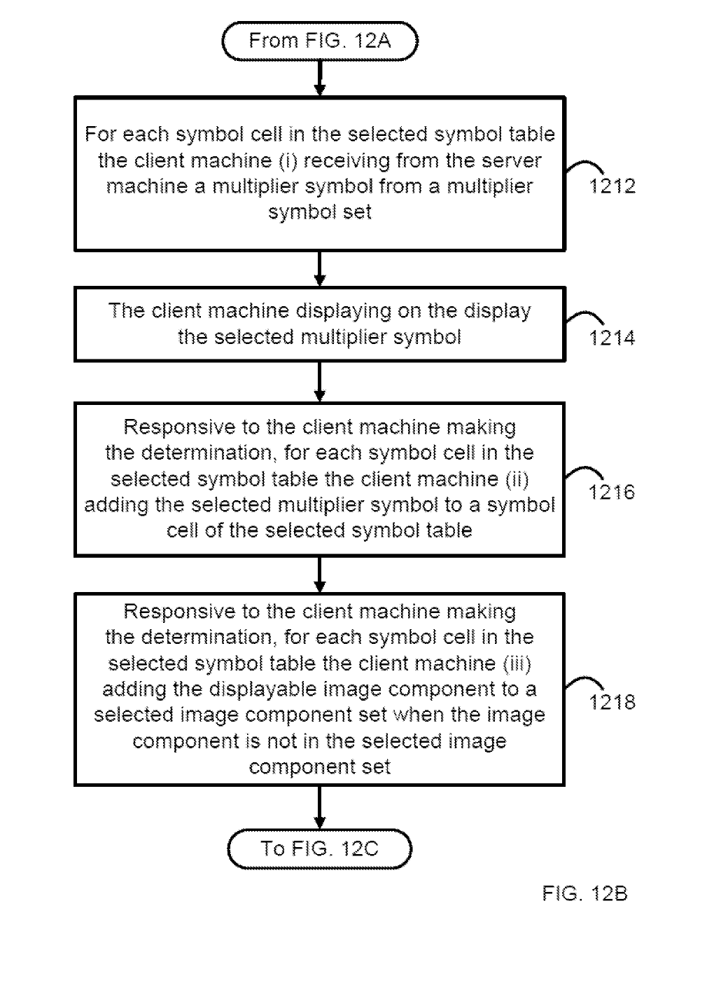

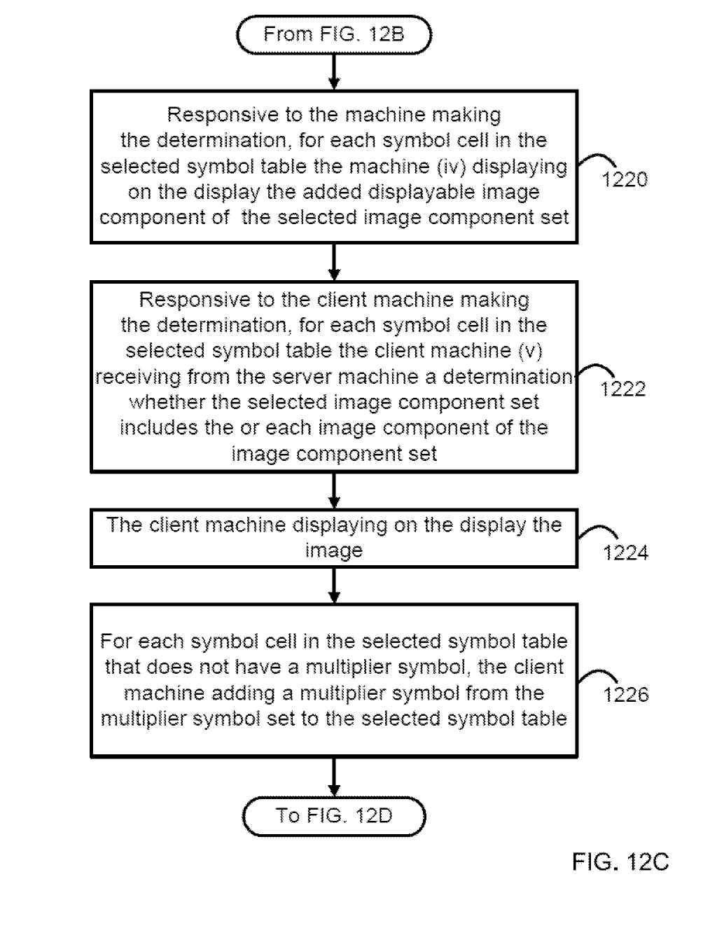

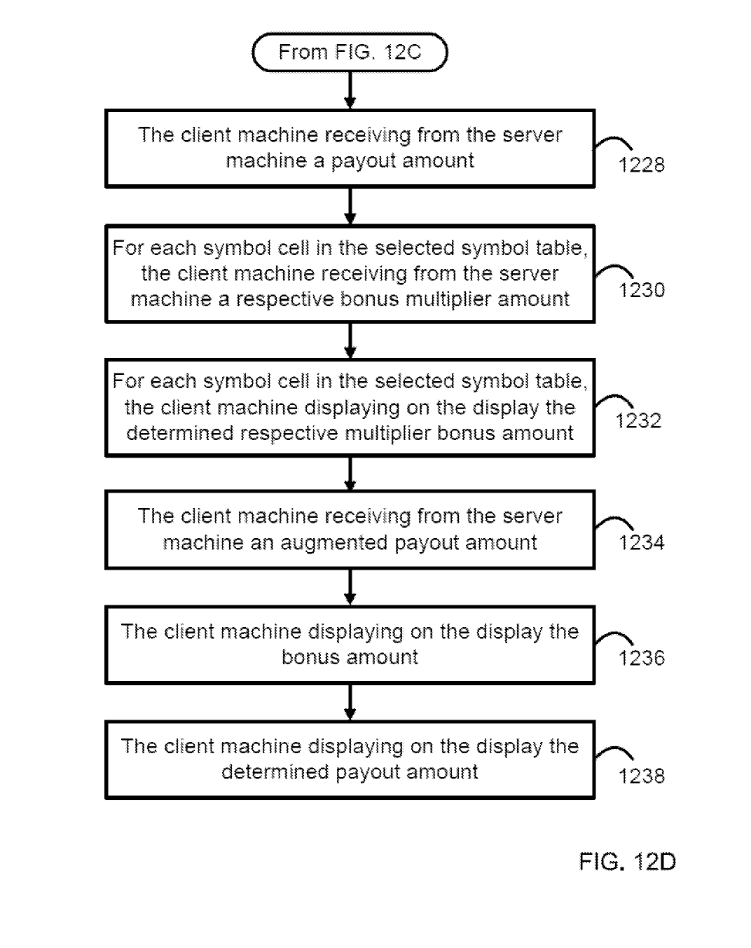

FIGS. 12A-12D show a flow chart showing functions in accordance with an example method in connection with the client machine 100b. Note that several of the functions described in connection with FIGS. 12A-12B parallel functions described in connection with FIGS. 3A-3C and 11A-11B. As such, variations of the functions described in connection with FIGS. 3A-3C and 11A-11B are likewise applicable to the functions described in connection with FIGS. 12A-12B. However, for the sake of brevity, these variations are not repeated.

At block 1200, the method may involve the client machine 100b sending a wager to the server machine 100a.

At block 1202, the method may involve the client machine 100b sending a play request to the server machine 100a.

At block 1204, the method may involve the client machine 100b sending to the server machine 100b a determination that a trigger event occurred.

At block 1206, the method may involve the client machine 100b displaying on the display a selected symbol table comprising a plurality of symbol cells.

At block 1208, the method may involve the client machine 100b displaying on the display the or each respective displayable image component of the image component set.

At block 1210, the method may involve the client machine 100b displaying on the display an outline of the image.

Turning to FIG. 12B, at block 1212, responsive to the client machine 100b making the determination, the method may involve the client machine 100b, for each symbol cell in the selected symbol table, receiving from the server machine a multiplier symbol from a multiplier symbol set.

For example, the client machine may receive data representing one or more multiplier symbols, respectively. Such data may represent one or more image files Or, in another example, the client machine may receive data indicating one or more image files representing one or more respective multiplier symbols that are stored at the client device. Or, as a further example, the client machine may receive one or more instructions for the client device to select one or more multiplier symbols.

In one embodiment, various functions are performed during each iteration, for a symbol cell, before proceeding to the next iteration, for the next symbol cell. For example, the machine may perform functions including block 1212, block 1214, block 1216, block 1218, block 1220, and block 1222 for a particular symbol cell during an iteration, before proceeding to another iteration involving a different symbol cell. Other embodiments may involve performing, during an iteration, none, all, or any combination of blocks 1212-1222, as well as other functions.

At block 1214, the method may involve, responsive to the client machine 100b making the determination, the client machine, for each symbol cell in the selected symbol table, displaying on the display the selected multiplier symbol.

At block 1216, the method may involve, responsive to the client machine 100b making the determination, the client machine, for each symbol cell in the selected symbol table, adding the selected multiplier symbol to a symbol cell of the selected symbol table.

At block 1218, the method may involve, responsive to the client machine 100b making the determination, the client machine, for each symbol cell in the selected symbol table, adding the displayable image component to a selected image component set when the image component is not in the selected image component set.

Turning to FIG. 12C, at block 1220, the method may involve, responsive to the client machine 100b making the determination, the client machine, for each symbol cell in the selected symbol table, displaying on the display the added displayable image component of the selected image component set.

At block 1222, the method may involve, responsive to the client machine 100b making the determination, the client machine, for each symbol cell in the selected symbol table, receiving from the server machine a determination whether the selected image component set includes the or each image component of the image component set.

At block 1224, the method may involve the client machine 100b displaying on the display the image, wherein the image is composed of the or each respective displayable image component of the selected image component set when the selected image component set includes the or each image component of the image component set.

At block 1226, the method may involve the client machine 100b, for the or each symbol cell in the selected symbol table that does not have a multiplier symbol, adding a multiplier symbol from the multiplier symbol set to the selected symbol table when the selected image component set includes each image component of the image component set.

Turning to FIG. 12D, at block 1228, the method may involve the client machine 100b receiving from the server machine 100a a payout amount, wherein the payout amount is a function of at least the received wager and one or more respective multipliers that are associated with the or each respective selected multiplier symbol.

At block 1230, the method may involve the client machine 100b, responsive to making the determination, for the or each selected multiplier symbol in the symbol table, receiving from the server machine 100a a respective multiplier bonus amount, wherein the multiplier bonus amount is a function of the respective multiplier and the wager.

At block 1232, the method may involve the client machine 100b, for the or each selected multiplier symbol in the symbol table, displaying on the display the determined respective multiplier bonus amount.

At block 1234, the method may involve the client machine 100b receiving from the server machine 100a an augmented payout amount, wherein the payout amount is augmented by a bonus amount when the selected image component set includes each image component of the image component set.

At block 1236, the method may involve the client machine 100b displaying on the display the bonus amount.

At block 1238, the method may involve the client machine 100b displaying on the display the determined payout amount.

The following examples set out further or alternative aspects of the disclosure. The references to items in Figures or to Figures are for ease of reference only and are not limiting on the scope of the disclosures in accordance with these various aspects. The machine in any of the following examples may be a component of any of the machines described herein or any configuration of a machine described herein.

1. A machine comprising: a display configured to display symbols in a game; a processor; and a non-transitory computer-readable medium storing program instructions, that when executed by the processor, cause a set of functions to be performed, the set of functions comprising:

making a determination that a trigger event occurred;

displaying on the display a selected symbol table comprising a plurality of symbol cells;

responsive to making the determination, for each symbol cell in the selected symbol table:
(i) randomly selecting a multiplier symbol from a multiplier symbol set;
(ii) adding the selected multiplier symbol to a symbol cell of the selected symbol table, wherein the selected multiplier symbol corresponds to a displayable image component, wherein the displayable image component is from an image component set, and wherein the image component set corresponds to an image;
(iii) adding the displayable image component to a selected image component set when the image component is not in the selected image component set;
(iv) displaying on the display the added displayable image component of the selected image component set; and
(v) determining whether the selected image component set includes the or each image component of the image component set.

2. The machine as recited in example 1, wherein the trigger event comprises a randomly occurring event.

3. The machine as recited in example 1 or 2, wherein the trigger event comprises selecting a trigger symbol.

4. The machine as recited in one of examples 1-3, wherein at least one symbol cell of the plurality of symbol cells does not have a multiplier symbol, the set of functions further comprising:

for the or each symbol cell in the selected symbol table that does not have a multiplier symbol, adding a multiplier symbol from the multiplier symbol set to the selected symbol table when the selected image component set includes each image component of the image component set.

5. The machine as recited in one of examples 1-4, the set of functions further comprising:

displaying on the display the image, wherein the image is composed of the or each respective displayable image component of the selected image component set when the selected image component set includes the or each image component of the image component set.

6. The machine as recited in one of examples 1-5, the set of functions further comprising:

displaying on the display the or each respective displayable image component of the image component set.

7. The machine recited in one of examples 1-6, wherein a payout table is stored in the computer-readable medium, the set of functions further comprising:

receiving a wager via a user interface; and

determining, using the stored payout table, a payout amount, wherein the payout amount is a function of at least the received wager and one or more respective multipliers that are associated with the or each respective selected multiplier symbol.

8. The machine as recited in example 7, the set of functions further comprising:

displaying on the display the determined payout amount.

9. The machine as recited in one of examples 7 or 8, the set of functions further comprising:

for the or each selected multiplier symbol in the symbol table, determining a respective multiplier bonus amount, wherein the multiplier bonus amount is a function of the respective multiplier and the wager.

10. The machine as recited in example 9, the set of functions further comprising:

for the or each selected multiplier symbol in the symbol table, displaying on the display the determined respective multiplier bonus amount.

11. The machine as recited in one of examples 9 or 10, wherein the payout amount is a sum of the respective multiplier bonus amounts.

12. The machine as recited in one of examples 7-11, the set of functions further comprising:

augmenting the payout amount by a bonus amount when the selected image component set includes each image component of the image component set.

13. The machine as recited in example 12, the set of functions further comprising:

displaying on the display the bonus amount.

14. The machine as recited in one of examples 1-13, wherein the machine further comprises a user interface, the set of functions further comprising:

receiving a play request via the user interface, wherein making the determination occurs in response to receiving the play request.

15. The machine as recited in one of examples 1-14, wherein the or each respective multiplier symbol of the multiplier symbol set indicates a respective die face.

16. The machine as recited in example 15, wherein the multiplier symbol set comprises six multiplier symbols.

17. The machine as recited in one of examples 1-14, wherein the or each respective multiplier symbol of the multiplier symbol set indicates a respective slot on a spinner.

18. The machine as recited in one of examples 1-17, wherein randomly selecting a multiplier symbol from a multiplier symbol set comprises:

using a random number generator to select numbers from a set of numbers to select multiplier symbols corresponding with the selected numbers.

19. The machine as recited in one of examples 1-18, the set of functions further comprising:

responsive to making the determination, for the or each symbol cell in a selected symbol table:

displaying on the display the selected multiplier symbol.

20. The machine as recited in one of examples 1-19, wherein displaying on the display the added image component of the selected image component set comprises highlighting the added image component.

21. The machine as recited in one of examples 1-20, the set of functions further comprising:

displaying on the display an outline of the image.

22. The machine as recited in example 21, wherein displaying on the display the added displayable image component comprises displaying the added displayable image component within the outline of the image.

23. The machine as recited in one of examples 1-22, wherein randomly selecting a multiplier symbol from a multiplier symbol set comprises:

making a second determination that a second trigger event occurred, and

responsive to the second determination, randomly selecting a multiplier symbol from the multiplier symbol set.

24. The machine as recited in one of examples 1-23, wherein the selected symbol table includes a first amount of symbol cells, wherein the multiplier symbol set includes a second amount of multiplier symbols, and wherein the first amount is greater than the second amount.

25. The machine as recited in one of examples 1-24, wherein the display is configured to display symbols in a wager game.

26. A method comprising:

a machine making a determination that a trigger event occurred;

the machine displaying on the display a selected symbol table comprising a plurality of symbol cells;

responsive to making the determination, for each symbol cell in the selected symbol table, the machine:
(i) randomly selecting a multiplier symbol from a multiplier symbol set;
(ii) adding the selected multiplier symbol to a symbol cell of the selected symbol table, wherein the selected multiplier symbol corresponds to a displayable image component, wherein the displayable image component is from an image component set, and wherein the image component set corresponds to an image;
(iii) adding the displayable image component to a selected image component set when the image component is not in the selected image component set;
(iv) displaying on the display the added displayable image component of the selected image component set; and
(v) determining whether the selected image component set includes the or each image component of the image component set.

27. The method as recited in example 26, wherein the trigger event comprises a randomly occurring event.

28. The method as recited in example 26 or 27, wherein the trigger event comprises the machine selecting a trigger symbol.

29. The method as recited in one of examples 26-28, wherein at least one symbol cell of the plurality of symbol cells does not have a multiplier symbol, further comprising:

for the or each symbol cell in the selected symbol table that does not have a multiplier symbol, the machine adding a multiplier symbol from the multiplier symbol set to the selected symbol table when the selected image component set includes each image component of the image component set.

30. The method as recited in one of examples 26-29, further comprising:

the machine displaying on the display the image, wherein the image is composed of the or each respective displayable image component of the selected image component set when the selected image component set includes the or each image component of the image component set.

31. The method as recited in one of examples 26-30, further comprising:

the machine displaying on the display the or each respective displayable image component of the image component set.

32. The method recited in one of examples 26-31, wherein the machine comprises a computer-readable medium, and wherein a payout table is stored in the computer-readable medium, further comprising:

the machine receiving a wager via a user interface; and

the machine determining, using the stored payout table, a payout amount, wherein the payout amount is a function of at least the received wager and one or more respective multipliers that are associated with the or each respective selected multiplier symbol.

33. The method as recited in example 32, further comprising:

the machine displaying on the display the determined payout amount.

34. The method as recited in one of examples 32 or 33, further comprising:

for the or each selected multiplier symbol in the symbol table, the machine determining a respective multiplier bonus amount, wherein the multiplier bonus amount is a function of the respective multiplier and the wager.

35. The method as recited in example 34, further comprising:

for the or each selected multiplier symbol in the symbol table, the machine displaying on the display the determined respective multiplier bonus amount.

36. The method as recited in one of examples 34 or 35, wherein the payout amount is a sum of the respective multiplier bonus amounts.

37. The method as recited in one of examples 32-36, further comprising:

the machine augmenting the payout amount by a bonus amount when the selected image component set includes each image component of the image component set.

38. The method as recited in example 37, further comprising:

the machine displaying on the display the bonus amount.

39. The method as recited in one of examples 26-38, wherein the machine further comprises a user interface, further comprising:

the machine receiving a play request via the user interface, wherein making the determination occurs in response to receiving the play request.

40. The method as recited in one of examples 26-39, wherein the or each respective multiplier symbol of the multiplier symbol set indicates a respective die face.

41. The method as recited in example 40, wherein the multiplier symbol set comprises six multiplier symbols.

42. The method as recited in one of examples 26-39 wherein the or each respective multiplier symbol of the multiplier symbol set indicates a respective slot on a spinner.

43. The method as recited in one of examples 26-42, wherein the machine randomly selecting a multiplier symbol from a multiplier symbol set comprises:

the machine using a random number generator to select numbers from a set of numbers to select multiplier symbols corresponding with the selected numbers.

44. The method as recited in one of examples 26-43, further comprising:

responsive to making the determination, for the or each symbol cell in a selected symbol table:

the machine displaying on the display the selected multiplier symbol.

45. The method as recited in one of examples 26-44, wherein the machine displaying on the display the added image component of the selected image component set comprises the machine highlighting the added image component.

46. The method as recited in one of examples 26-45, further comprising:

the machine displaying on the display an outline of the image.

47. The method as recited in example 46, wherein the machine displaying on the display the added displayable image component comprises the machine displaying the added displayable image component within the outline of the image.

48. The method as recited in one of examples 26-47, wherein the machine randomly selecting a multiplier symbol from a multiplier symbol set comprises:

the machine making a second determination that a second trigger event occurred, and

responsive to the second determination, the machine randomly selecting a multiplier symbol from the multiplier symbol set.

49. The method as recited in one of examples 26-48, wherein the selected symbol table includes a first amount of symbol cells, wherein the multiplier symbol set includes a second amount of multiplier symbols, and wherein the first amount is greater than the second amount.

50. The method recited as in one of examples 26-49, wherein the display is configured to display symbols in a wager game.

51. A server machine comprising: a processor; and a non-transitory computer-readable medium storing program instructions, that when executed by the processor, cause a set of functions to be performed, the set of functions comprising:

making a determination that a trigger event occurred;

sending to a client machine for display a selected symbol table comprising a plurality of symbol cells;

responsive to making the determination, for each symbol cell in the selected symbol table:
(i) randomly selecting a multiplier symbol from a multiplier symbol set;
(ii) adding the selected multiplier symbol to a symbol cell of the selected symbol table, wherein the selected multiplier symbol corresponds to a displayable image component, wherein the displayable image component is from an image component set, and wherein the image component set corresponds to an image;
(iii) adding the displayable image component to a selected image component set when the image component is not in the selected image component set;
(iv) sending to the client machine for display the added displayable image component of the selected image component set; and
(v) determining whether the selected image component set includes the or each image component of the image component set.

52. The server machine as recited in example 51, wherein the trigger event comprises a randomly occurring event.

53. The server machine as recited in example 51 or 52, wherein the trigger event comprises selecting a trigger symbol.

54. The server machine as recited in one of examples 51-53, wherein at least one symbol cell of the plurality of symbol cells does not have a multiplier symbol, the set of functions further comprising:

for the or each symbol cell in the selected symbol table that does not have a multiplier symbol, adding a multiplier symbol from the multiplier symbol set to the selected symbol table when the selected image component set includes each image component of the image component set.

55. The server machine as recited in one of examples 51-54, the set of functions further comprising:

sending to the client machine for display the image, wherein the image is composed of the or each respective displayable image component of the selected image component set when the selected image component set includes the or each image component of the image component set.

56. The server machine as recited in one of examples 51-55, the set of functions further comprising:

sending to the client machine for display the or each respective displayable image component of the image component set.

57. The server machine recited in one of examples 51-56, wherein a payout table is stored in the computer-readable medium, the set of functions further comprising:

receiving a wager from a client machine; and

determining, using the stored payout table, a payout amount, wherein the payout amount is a function of at least the received wager and one or more respective multipliers that are associated with the or each respective selected multiplier symbol.

58. The server machine as recited in example 57, the set of functions further comprising:

sending to the client machine for display the determined payout amount.

59. The server machine as recited in one of examples 57 or 58, the set of functions further comprising:

for the or each selected multiplier symbol in the symbol table, determining a respective multiplier bonus amount, wherein the multiplier bonus amount is a function of the respective multiplier and the wager.

60. The server machine as recited in example 59, the set of functions further comprising:

for the or each selected multiplier symbol in the symbol table, sending to the client machine for display the determined respective multiplier bonus amount.

61. The server machine as recited in one of examples 59 or 60, wherein the payout amount is a sum of the respective multiplier bonus amounts.

62. The server machine as recited in one of examples 57-61, the set of functions further comprising:

augmenting the payout amount by a bonus amount when the selected image component set includes each image component of the image component set.

63. The server machine as recited in example 62, the set of functions further comprising:

sending to the client machine for display the bonus amount.

64. The server machine as recited in one of examples 51-63, the set of functions further comprising:

receiving a play request from the client machine, wherein making the determination occurs in response to receiving the play request.

65. The server machine as recited in one of examples 51-64, wherein the or each respective multiplier symbol of the multiplier symbol set indicates a respective die face.

66. The server machine as recited in example 65, wherein the multiplier symbol set comprises six multiplier symbols.

67. The server machine as recited in one of examples 51-64, wherein the or each respective multiplier symbol of the multiplier symbol set indicates a respective slot on a spinner.

68. The server machine as recited in one of examples 51-67, wherein randomly selecting a multiplier symbol from a multiplier symbol set comprises:

using a random number generator to select numbers from a set of numbers to select multiplier symbols corresponding with the selected numbers.

69. The server machine as recited in one of examples 51-68, the set of functions further comprising:

responsive to making the determination, for the or each symbol cell in a selected symbol table:

sending to the client machine for display the selected multiplier symbol.

70. The server machine as recited in one of examples 51-69, wherein sending to the client machine for display the added image component of the selected image component set comprises highlighting the added image component.

71. The server machine as recited in one of examples 51-70, the set of functions further comprising:

sending to the client machine for display an outline of the image.

72. The server machine as recited in example 71, wherein sending to the client machine for display the added displayable image component comprises sending to the client machine for display the added displayable image component within the outline of the image.

73. The server machine as recited in one of examples 51-72, wherein randomly selecting a multiplier symbol from a multiplier symbol set comprises:

making a second determination that a second trigger event occurred, and

responsive to the second determination, randomly selecting a multiplier symbol from the multiplier symbol set.

74. The server machine as recited in one of examples 51-73, wherein the selected symbol table includes a first amount of symbol cells, wherein the multiplier symbol set includes a second amount of multiplier symbols, and wherein the first amount is greater than the second amount.

75. The server machine as recited in one of examples 1-24, wherein the server machine is configured to send to the client machine for display symbols in a wager game.

76. A client machine comprising: a display configured to display symbols in a game; a processor; and a non-transitory computer-readable medium storing program instructions, that when executed by the processor, cause a set of functions to be performed, the set of functions comprising:

making a determination that a trigger event occurred;

displaying on the display a selected symbol table comprising a plurality of symbol cells;

responsive to making the determination, for each symbol cell in the selected symbol table, the client machine:
(i) receiving from the server machine a multiplier symbol from a multiplier symbol set;
(ii) adding the selected multiplier symbol to a symbol cell of the selected symbol table, wherein the selected multiplier symbol corresponds to a displayable image component, wherein the displayable image component is from an image component set, and wherein the image component set corresponds to an image;
(iii) adding the displayable image component to a selected image component set when the image component is not in the selected image component set;
(iv) displaying on the display the added displayable image component of the selected image component set; and
(v) receiving from the server machine a determination whether the selected image component set includes the or each image component of the image component set.

77. The client machine as recited in example 76, wherein the trigger event comprises a randomly occurring event.

78. The client machine as recited in example 76 or 77, wherein the trigger event comprises the server machine selecting a trigger symbol.

79. The client machine as recited in one of examples 76-78, wherein at least one symbol cell of the plurality of symbol cells does not have a multiplier symbol, further comprising:

for the or each symbol cell in the selected symbol table that does not have a multiplier symbol, the client machine adding a multiplier symbol from the multiplier symbol set to the selected symbol table when the selected image component set includes each image component of the image component set.

80. The client machine as recited in one of examples 76-79, the set of functions further comprising:

displaying on the display the image, wherein the image is composed of the or each respective displayable image component of the selected image component set when the selected image component set includes the or each image component of the image component set.

81. The client machine as recited in one of examples 76-80, the set of functions further comprising:

displaying on the display the or each respective displayable image component of the image component set.

82. The client machine recited in one of examples 76-81, the set of functions further comprising:

sending a wager to the server machine; and

receiving from the server machine a payout amount, wherein the payout amount is a function of at least the received wager and one or more respective multipliers that are associated with the or each respective selected multiplier symbol.

83. The client machine as recited in example 82, the set of functions further comprising:

displaying on the display the determined payout amount.

84. The client machine as recited in one of examples 82 or 83, the set of functions further comprising:

responsive to making the determination, for the or each selected multiplier symbol in the symbol table, receiving from the server machine a respective multiplier bonus amount, wherein the multiplier bonus amount is a function of the respective multiplier and the wager.

85. The client machine as recited in example 84, the set of functions further comprising:

for the or each selected multiplier symbol in the symbol table, displaying on the display the received respective multiplier bonus amount.

86. The client machine as recited in one of examples 84 or 85, wherein the payout amount is a sum of the respective multiplier bonus amounts.

87. The client machine as recited in one of examples 82-86, the set of functions further comprising:

receiving from the server machine an augmented payout amount, wherein the payout amount is augmented by a bonus amount when the selected image component set includes each image component of the image component set.

88. The client machine as recited in example 87, the set of functions further comprising:

displaying on the display the bonus amount.

89. The client machine as recited in one of examples 76-88, the set of functions further comprising:

sending a play request to the server machine, wherein making the determination occurs in response to receiving the play request.

90. The client machine as recited in one of examples 76-89, wherein the or each respective multiplier symbol of the multiplier symbol set indicates a respective die face.

91. The client machine as recited in example 90, wherein the multiplier symbol set comprises six multiplier symbols.

92. The client machine as recited in one of examples 76-89, wherein the or each respective multiplier symbol of the multiplier symbol set indicates a respective slot on a spinner.

93. The client machine as recited in one of examples 76-92, the set of functions further comprising:

responsive to making the determination, for the or each symbol cell in a selected symbol table:

displaying on the display the selected multiplier symbol.

94. The client machine as recited in one of examples 76-93, wherein displaying on the display the added image component of the selected image component set comprises highlighting the added image component.

95. The client machine as recited in one of examples 76-94, the set of functions further comprising:

displaying on the an outline of the image.

96. The client machine as recited in example 95, wherein displaying on the display the added displayable image component displaying on the display the added displayable image component within the outline of the image.

97. The client machine as recited in one of examples 76-96, wherein the selected symbol table includes a first amount of symbol cells, wherein the multiplier symbol set includes a second amount of multiplier symbols, and wherein the first amount is greater than the second amount.

98. The client machine as recited in one of examples 76-97, wherein the client machine is configured to receive from the server machine for display symbols in a wager game.

In general, currently there are no machines or methods that allow a player to play a game that involves for each symbol cell in a selected symbol table: (i) randomly selecting a multiplier symbol from a multiplier symbol set; (ii) adding the selected multiplier symbol to a symbol cell of the selected symbol table, wherein the selected multiplier symbol corresponds to a displayable image component, wherein the displayable image component is from an image component set, and wherein the image component set corresponds to an image; (iii) adding the displayable image component to a selected image component set when the image component is not in the selected image component set; (iv) displaying on the display the added displayable image component of the selected image component set; and (v) determining whether the selected image component set includes the or each image component of the image component set.

More particularly, currently, there are no machines or methods to provide a symbol-type game that involves making a determination that a trigger event occurred; displaying on the display a selected symbol table comprising a plurality of symbol cells; responsive to making the determination, for each symbol cell in the selected symbol table: (i) randomly selecting a multiplier symbol from a multiplier symbol set; (ii) adding the selected multiplier symbol to a symbol cell of the selected symbol table, wherein the selected multiplier symbol corresponds to a displayable image component, wherein the displayable image component is from an image component set, and wherein the image component set corresponds to an image; (iii) adding the displayable image component to a selected image component set when the image component is not in the selected image component set; (iv) displaying on the display the added displayable image component of the selected image component set; and (v) determining whether the selected image component set includes the or each image component of the image component set.

While one or more functions of the presently disclosed method have been described as being performed by the certain entities (e.g., the machine 100, the server machine 100a, or the client machine 100b), one or more of the functions may be performed by any entity, including but not limited to those described herein. As such, while this disclosure includes examples in which the server machine 100a performs select functions and sends data to the client machine 100b, such that the client machine 100b may perform complementing functions and receive the data, variations may to those functions may be made while adhering to the general server-client dichotomy and the scope of the disclosed machines and methods.

For example, rather than the server machine 100a sending select data (e.g., a symbol set) to the client machine 100b, such that the client machine may generate and display appropriate images, the server machine 100a may itself generate the images and send them to the client machine 100b for display. Indeed, it will be appreciated by one of ordinary skill in the art that the “break point” between the server machine's functions and the client machine's functions may be varied with ease.

Further, the described functions throughout this application need not be performed in the disclosed order, although in some examples, the recited order may be preferred. Also, not all functions need to be performed to achieve the desired advantages of disclosed machines and methods, and therefore not all functions are required

While examples have been described in terms of select embodiments, alterations and permutations of these embodiments will be apparent to those of ordinary skill in the art. Other changes, substitutions, and alterations are also possible without departing from the disclosed machines and methods in their broader aspects as set forth in the following claims.

1. A machine comprising: a display configured to display symbols in a game; a processor; and a non-transitory computer-readable medium storing program instructions, that when executed by the processor, cause a set of functions to be performed, the set of functions comprising:
making a determination that a trigger event occurred;
displaying on the display a selected symbol table comprising a plurality of symbol cells;
responsive to making the determination, for each symbol cell in the selected symbol table:
(i) randomly selecting a multiplier symbol from a multiplier symbol set;
(ii) adding the selected multiplier symbol to a symbol cell of the selected symbol table, wherein the selected multiplier symbol corresponds to a displayable image component, wherein the displayable image component is from an image component set, and wherein the image component set corresponds to an image;
(iii) adding the displayable image component to a selected image component set when the image component is not in the selected image component set;
(iv) displaying on the display the added displayable image component of the selected image component set; and
(v) determining whether the selected image component set includes the or each image component of the image component set.

2. The machine as recited in claim 1, wherein at least one symbol cell of the plurality of symbol cells does not have a multiplier symbol, the set of functions further comprising:
for the or each symbol cell in the selected symbol table that does not have a multiplier symbol, adding a multiplier symbol from the multiplier symbol set to the selected symbol table when the selected image component set includes each image component of the image component set.

3. The machine as recited in claim 1, the set of functions further comprising:
displaying on the display the image, wherein the image is composed of the or each respective displayable image component of the selected image component set when the selected image component set includes the or each image component of the image component set.

4. The machine as recited in claim 1, the set of functions further comprising:
displaying on the display the or each respective displayable image component of the image component set.

5. The machine recited in claim 1, wherein a payout table is stored in the computer-readable medium, the set of functions further comprising:
receiving a wager via a user interface; and
determining, using the stored payout table, a payout amount, wherein the payout amount is a function of at least the received wager and one or more respective multipliers that are associated with the or each respective selected multiplier symbol.

6. The machine as recited in claim 5, the set of functions further comprising:
displaying on the display the determined payout amount.

7. The machine as recited in claim 5, the set of functions further comprising:
for the or each selected multiplier symbol in the symbol table, determining a respective multiplier bonus amount, wherein the multiplier bonus amount is a function of the respective multiplier and the wager.

8. The machine as recited in claim 7, the set of functions further comprising:
for the or each selected multiplier symbol in the symbol table, displaying on the display the determined respective multiplier bonus amount.

9. The machine as recited claim 7, wherein the payout amount is a sum of the respective multiplier bonus amounts.

10. The machine as recited in claim 5, the set of functions further comprising:
augmenting the payout amount by a bonus amount when the selected image component set includes each image component of the image component set.

11. The machine as recited in claim 10, the set of functions further comprising:
displaying on the display the bonus amount.

12. A method comprising:
a machine making a determination that a trigger event occurred;
the machine displaying on the display a selected symbol table comprising a plurality of symbol cells;
responsive to making the determination, for each symbol cell in the selected symbol table, the machine:
(i) randomly selecting a multiplier symbol from a multiplier symbol set;
(ii) adding the selected multiplier symbol to a symbol cell of the selected symbol table, wherein the selected multiplier symbol corresponds to a displayable image component, wherein the displayable image component is from an image component set, and wherein the image component set corresponds to an image;
(iii) adding the displayable image component to a selected image component set when the image component is not in the selected image component set;
(iv) displaying on the display the added displayable image component of the selected image component set; and
(v) determining whether the selected image component set includes the or each image component of the image component set.

13. The method as recited in claim 12, wherein the or each respective multiplier symbol of the multiplier symbol set indicates a respective die face.

14. The method as recited in claim 13, wherein the multiplier symbol set comprises six multiplier symbols.

15. The method as recited in claim 12, wherein the or each respective multiplier symbol of the multiplier symbol set indicates a respective slot on a spinner.

16. The method as recited in claim 12, further comprising:
the machine displaying on the display an outline of the image.

17. The method as recited in claim 16, wherein the machine displaying on the display the added displayable image component comprises the machine displaying the added displayable image component within the outline of the image.

18. The method as recited in claim 12, wherein the machine randomly selecting a multiplier symbol from a multiplier symbol set comprises:
the machine making a second determination that a second trigger event occurred, and
responsive to the second determination, the machine randomly selecting a multiplier symbol from the multiplier symbol set.

19. The method as recited in claim 12, wherein the selected symbol table includes a first amount of symbol cells, wherein the multiplier symbol set includes a second amount of multiplier symbols, and wherein the first amount is greater than the second amount.

20. A server machine comprising: a processor; and a non-transitory computer-readable medium storing program instructions, that when executed by the processor, cause a set of functions to be performed, the set of functions comprising:
making a determination that a trigger event occurred;
sending to a client machine for display a selected symbol table comprising a plurality of symbol cells;
responsive to making the determination, for each symbol cell in the selected symbol table:
(i) randomly selecting a multiplier symbol from a multiplier symbol set;
(ii) adding the selected multiplier symbol to a symbol cell of the selected symbol table, wherein the selected multiplier symbol corresponds to a displayable image component, wherein the displayable image component is from an image component set, and wherein the image component set corresponds to an image;
(iii) adding the displayable image component to a selected image component set when the image component is not in the selected image component set;
(iv) sending to the client machine for display the added displayable image component of the selected image component set; and
(v) determining whether the selected image component set includes the or each image component of the image component set.

21. A client machine comprising: a display configured to display symbols in a game; a processor; and a non-transitory computer-readable medium storing program instructions, that when executed by the processor, cause a set of functions to be performed, the set of functions comprising:
making a determination that a trigger event occurred;
displaying on the display a selected symbol table comprising a plurality of symbol cells;
responsive to making the determination, for each symbol cell in the selected symbol table, the client machine:
(i) receiving from the server machine a multiplier symbol from a multiplier symbol set;
(ii) adding the selected multiplier symbol to a symbol cell of the selected symbol table, wherein the selected multiplier symbol corresponds to a displayable image component, wherein the displayable image component is from an image component set, and wherein the image component set corresponds to an image;
(iii) adding the displayable image component to a selected image component set when the image component is not in the selected image component set;
(iv) displaying on the display the added displayable image component of the selected image component set; and
(v) receiving from the server machine a determination whether the selected image component set includes the or each image component of the image component set.
